(19) United States
(12) Patent Application Publication
(10) Pub. No.: US 2009/0268571 A1
(43) Pub. Date: Oct. 29, 2009

(54) Optical recording control method, optical recording control circuit, optical reproduction control method, optical reproduction control circuit, optical recording medium, tracking control method, tracking control circuit, optical recording method, optical recording apparatus, optical reproduction method, and optical reproduction apparatus

(76) Inventor: Yoshiharu Kobayashi, Osaka (JP)

Correspondence Address: WENDEROTH, LIND & PONACK L.L.P., 1030 15th Street, N.W., Suite 400 East, Washington, DC, 20005-1503, US

(21) Appl. No.: 11/918,411

(22) PCT Filed: Apr. 11, 2006
(86) PCT No.: PCT/JP2006/307647

§ 371 Date: Oct. 12, 2007

(30) Foreign Application Priority Data
Apr. 14, 2005 (JP) 2005-116839
May 26, 2005 (JP) 2005-153479

(51) Int. Cl. G11B 7/12; G11B 7/135

(52) U.S. Cl. 369/47.51; 369/112.01; G9B/7

(57) ABSTRACT

An object of the invention is to increase a transfer rate in data recording or data reproduction. A beam spot 10 is cyclically moved in a track set with a predetermined pattern. The track set is constituted of adjacent tracks of a predetermined number. In recording, the power of a laser beam is impulsively controlled with a predetermined intensity when the beam spot 10 crosses the middle of each of tracks 11, 12, and 13 to record data in the track set constituted of the tracks 11, 12, and 13. In reproduction, the data recorded in the track set constituted of the tracks 11, 12, and 13 is reproduced by sampling a reproduction signal to be generated in receiving reflected light of the light beam when the beam spot 10 crosses the middle of each of the tracks 11, 12, and 13.

### TECHNICAL FIELD

The present invention relates to an optical recording medium for recording data therein. The present invention also relates to an optical recording control method for recording data in an optical recording medium, an optical recording control circuit, an optical recording method, and an optical recording apparatus. The present invention further relates to an optical reproduction control method for reproducing data from an optical recording medium, an optical reproduction control circuit, an optical reproduction method, and an optical reproduction apparatus. The present invention furthermore relates to a tracking control method for controlling tracking operations, and a tracking control circuit.

### BACKGROUND ART

Primarily, there have been proposed two methods for increasing a data transfer rate of an optical recording medium i.e. so-called an optical disk. One of the methods is to increase the linear recording density by increasing the numerical aperture of an objective lens, and shortening the laser wavelength to thereby increase a data transfer rate in recording and a data transfer rate in reproduction. Specifically, assuming that the linear velocity of an optical disk is constant, the linear recording density can be increased by decreasing the diameter of a focus spot of a laser beam is decreased (i.e. increasing the numerical aperture of an objective lens, or decreasing the laser wavelength). Thereby, the number of recordable or reproducible data per unit time, i.e., a data transfer rate can be increased.

For instance, the linear recording density, the linear velocity, and the data transfer rate of a DVD-RAM disk having a recording capacity of 4.7 GB are respectively 3.57 bit/μm, 8.3 m/s, and 22.16 Mbps. The linear recording density, the linear velocity, and the data transfer rate of a BD (Blu-ray disk) having a recording capacity of 25 GB are respectively 8.95 bit/μm, 4.917 m/s, and 35.965 Mbps. The data transfer rate of the BD is about 1.6 times as large as that of the DVD-RAM disk, the linear density of the BD is about 2.5 times as large as that of the DVD-RAM disk, and the linear velocity of the BD is about 0.6 times as large as the DVD-RAM disk. Thus, the data transfer rate performance of the BD, as compared with the DVD-RAM disk is substantially coincident with a data transfer rate based on the linear density and the linear velocity: 2.5×0.6=1.5.

The other method is to increase the data transfer rate by increasing the linear velocity. Assuming that the linear recording density is constant, the data transfer rate in reproduction is proportional to the linear velocity. For instance, assuming that the linear velocity of a DVD-RAM disk is 16.3 m/s, which is about twice as large as 8.3 m/s, the data transfer rate is 44.32 Mbps.

Another technique other than the above is e.g. disclosed in Japanese Unexamined Patent Publication No. Hei 11-86295 (D1). D1 discloses an optical disk device for performing recording or reproduction, in which a beam spot formed on an optical disk having multiple spiral tracks is cyclically moved in a range of a set of multiple spiral tracks. The optical disk device has a well-known optical head, wherein a galvanometric mirror is disposed at a position corresponding to a rising mirror, and the beam spot on the optical disk is oscillated by oscillating the galvanometric mirror. In a normal operating condition, reproduction light with a fixed optical power is irradiated onto the optical disk; recording is performed by modulating the power of a laser beam depending on data to be recorded at a timing when a tracking signal crosses zero; and reproduction is performed by detecting reflected light of the reproduction light and by sampling a detection signal at a timing when the tracking signal crosses zero.

As a method for oscillating the beam spot on the optical disk, there are proposed a technique of oscillating the objective lens by a piezoelectric device, and a technique of oscillating a light polarization device disposed in front of the objective lens, in addition to the technique of oscillating the beam spot by the galvanometric mirror.

The aforementioned methods have involved the following drawbacks.

The method for increasing the data transfer rate by increasing the recording density i.e. the method for increasing the data transfer rate by increasing the recording density by decreasing the spot diameter of a laser beam has almost reached a limit. For instance, the BD uses a laser beam of 405 nm in wavelength, and an objective lens with 0.85 in numerical aperture. Further shortening the laser wavelength in an attempt to increase the recording density results in need of an ultraviolet laser, which makes it difficult to put the method into practice. Concerning an idea of increasing the numerical aperture more than 0.85, mounting such a lens with precision is difficult, not to mention production of a lens with such a large numerical aperture. Also, if the numerical aperture exceeds 1, it is necessary to use an immersion lens or a like device to perform near-field recording, in place of a well-known lens. It is extremely difficult to realize these arrangements. Accordingly, the method for increasing the data transfer rate by increasing the recording density i.e. by decreasing the spot diameter of a laser beam has reached a limit.

There is proposed a method for increasing the data transfer rate by increasing the linear velocity. This method also has almost reached a limit. Generally, it is reported that the limit of the number of rotations of an optical disk is about 10,000 rpm. Let us consider a case that a data transfer rate of a DVD-RAM disk is increased, with the number of rotations of an optical disk being applied to the DVD-RAM disk. In such a case, the number of rotations of a DVD-RAM disk with a single speed is about 3,300 rpm (at an innermost circumferential position, i.e. 24 mm radially distanced from the center of rotation). Accordingly, the data transfer rate is 10,000/3,300=about three times as large i.e. 67.2 Mbps. If the number of rotations is applied to a BD, the data transfer rate of the BD is 10,000/1,956=about 5.1 times as large i.e. 183.9 Mbps, because the number of rotations of the BD with a single speed is about 1,956 rpm. Accordingly, a data transfer rate obtained by rotating the BD with the recording density limit as the optical disk at 10,000 rpm, which is the rotation number limit of the optical disk may be defined as a data transfer rate limit of the optical disk. As compared with a fact that the data transfer rate of the current available HDD (hard disk drive) is as large as 500 Mbps or more, it may be concluded that the optical disk with the data transfer rate limit, which is smaller than one-half of the data transfer rate of the HDD, presents a challenging task to overcome.

The aforementioned task has been aware of for quite a long time. The optical disk device recited in D1 provides a measure for the task. The optical disk device recited in D1, however, has disadvantages concerning realization and effect for the following reasons.

Firstly, D1 is silent about quantitative description as to how much the data transfer rate will be increased. Generally, data is not recorded in a recording medium as it is, but is recorded after the data is converted into a code called as a recording code in accordance with a characteristic of a communication path of the recording medium. The recording code of an optical disk is called as a run-length limited code, whose run-length (a sequence of 0 as a code) is limited, and a frequency component of the recording code is lower than that of original data to be recorded. This is because the recording code is recorded in accordance with a low-pass characteristic of the communication path of the optical disk, in light of a fact that the size of the beam spot is limited. In the BD, 17 pp code is used as the recording code. Generally, recording and reproduction to and from the optical disk is performed in units of clock cycles of the recording code. D1, however, has no specific description as to how the recording code is processed in units of clock cycles.

Even if the recording code is processed in units of clock cycles, the operation frequency of the galvanometric mirror is at most 100 KHz or smaller. In light of the fact that the clock cycle of the recording code of the BD is 66 MHz, no further increase of the data transfer rate can be expected. Accordingly, it is necessary to provide a method for cyclically moving the beam spot with a high frequency.

Also, even if the frequency with which the beam spot is cyclically moved is not a bottle neck in increasing the data transfer rate, the length of a recording response time may affect the data transfer rate. The DVD-RAM disk or the BD employs a phase change system. The phase change system has a feature that recording data can be overwritten, in other words, new recording data can be directly recorded over the previously recorded data. The recording response in overwriting can be divided into two responses: erasing (crystallization) and recording (amorphousizing). A crystallized part and an amorphous part are called as a mark or a space, and correspond to a portion where a sequence of “1” continues and a portion where a sequence of “0” continues on the run-length limited code coded by PWM (Pulse Width Modulation) coding, respectively.

As mentioned above, the recording to the optical disk is performed in units of clock cycles of the recording code. However, it is necessary to complete the erasing (crystallization) and the recording (amorphousizing) within the clock cycle. Particularly, the time required for erasing i.e. the time required for crystallization may be a bottle neck. The erasing performance is represented by a crystallization rate or an erasing rate. Generally, it is desirable to achieve the erasing rate of about 30 dB. According to a document, the linear velocity of about 50 m/s is a limit to obtain the erasing rate of 30 dB (Optical Data Storage Topical Meeting, 1997. ODS Conference Digest, 7-9 Apr. 1997, pp. 98-99).

In the arrangement of D1, recording is performed with a track pitch interval. For instance, let us assume that the track pitch is set to 4.3 times as large as the length of the clock cycle of the recording code on the optical disk, based on the parameter of the BD, and the erasing rate of 30 dB can be retained until the relative speed of the beam spot to the optical disk is increased to 215 m/s, which is 4.3 times as fast as the normal relative speed. Then, the linear velocity of the optical disk is 12.4 m/s in order to record the recording code in units of clock cycles by moving the beam spot within three tracks with a triangular waveform pattern. The moving distance of the beam spot per cycle corresponds to 17.228 clock length as a recording code length, and the time cycle is 5.97 nsec. The data transfer rate is 3/(1.5×5.97 nsec)=335 Mbps. Even if the beam spot is moved within the three tracks, the data transfer rate is lower than 500 Mbps, which is the data transfer rate of the current available HDD.

Secondly, although D1 describes a reproduction apparatus, D1 does not disclose a specific embodiment concerning a recording apparatus. Normally, not only a phase change optical disk such as the BD, but also a magneto optical disk or a write-once optical disk using an organic pigment employs a thermal recording system. In such an arrangement, a recording compensation process considering heat diffusion is required. The recording compensation process to be executed in recording data by two-dimensionally moving the beam spot, as disclosed in D1, may involve a complex arrangement, unlike a recording compensation process to be executed in an ordinary arrangement of moving a beam spot one-dimensionally. However, D1 does not recite the description concerning the arrangement of the recording compensation process.

Thirdly, D1 has no description about position control of a beam spot. Specifically, D1 is silent about a method for controlling the position of a beam spot in recording data by successively irradiating the beam spot onto a certain number of tracks. D1 also does not recite a method for controlling the position of the beam spot in reproducing the data recorded in the tracks by moving the beam spot. Specifically, in reproducing the recorded data, the trajectory of the movement of the beam spot in recording is required to be identical to the trajectory of the movement of the beam spot in reproduction. In the case where the beam spot is moved two-dimensionally, the position control of the beam spot is much difficult, as compared with the arrangement that the beam spot is moved one-dimensionally.

As mentioned above, it is difficult to realize the arrangement of the optical disk device recited in D1 because not only increasing the data transfer rate is substantially difficult, but also D1 is silent about the recording compensation process, and a method for controlling the position of the beam spot, which are indispensable in realizing the arrangement.

### DISCLOSURE OF THE INVENTION

In view of the problems residing in the prior art, it is an object of the invention to provide an optical recording control method capable of increasing a data transfer rate, an optical recording control circuit, an optical reproduction control method, an optical reproduction control circuit, an optical recording medium, a tracking control method, a tracking control circuit, an optical recording method, an optical recording apparatus, an optical reproduction method, and an optical reproduction apparatus.

An optical recording control method according to an aspect of the invention comprises: a movement designation step of designating a light beam to cyclically move in a track set with a predetermined pattern, the track set being constituted of adjacent tracks of a predetermined number; and a recording designation step of designating recording of data in the track set by controlling a power of the light beam so that the light beam is impulsively irradiated with a predetermined intensity when the light beam crosses a middle of each of the tracks.

An optical recording control circuit according to another aspect of the invention comprises a movement designator for designating a light beam to cyclically move in a track set with a predetermined pattern, the track set being constituted of adjacent tracks of a predetermined number; and a recording designator for designating recording of data in the track set by controlling a power of the light beam so that the light beam is impulsively irradiated with a predetermined intensity when the light beam crosses a middle of each of the tracks.

An optical recording method according to another aspect of the invention comprises a moving step of cyclically moving a light beam in a track set with a predetermined pattern, the track set being constituted of adjacent tracks of a predetermined number; and a recording step of recording data in the track set by controlling a power of the light beam so that the light beam is impulsively irradiated with a predetermined intensity when the light beam crosses a middle of each of the tracks.

An optical recording apparatus according to another aspect of the invention comprises a mover for cyclically moving a light beam in a track set with a predetermined pattern, the track set being constituted of adjacent tracks of a predetermined number; and a recorder for recording data in the track set by controlling a power of the light beam so that the light beam is impulsively irradiated with a predetermined intensity when the light beam crosses a middle of each of the tracks.

An optical reproduction control method according to another aspect of the invention comprises a movement designation step of designating a light beam to cyclically move in a track set with a predetermined pattern, the track set being constituted of adjacent tracks of a predetermined number; and a reproduction designation step of designating reproduction of data recorded in the track set by sampling a reproduction signal to be generated in receiving reflected light of the light beam when the light beam crosses a middle of each of the tracks, wherein the cycle of the movement of the light beam in the track set is coincident with a cycle of one-channel bit length of a recording code to be recorded in a tracking direction.

An optical reproduction control circuit according to another aspect of the invention comprises a movement designator for designating a light beam to cyclically move in a track set with a predetermined pattern, the track set being constituted of adjacent tracks of a predetermined number; and a reproduction designator for designating reproduction of data recorded in the track set by sampling a reproduction signal to be generated in receiving reflected light of the light beam when the light beam crosses a middle of the track, wherein the cycle of the movement of the light beam in the track set is coincident with a cycle of one-channel bit length of a recording code to be recorded in a tracking direction.

An optical reproduction method according to another aspect of the invention comprises a moving step of cyclically moving a light beam in a track set with a predetermined pattern, the track set being constituted of adjacent tracks of a predetermined number; and a reproduction step of reproducing data recorded in the track set by sampling a reproduction signal to be generated in receiving reflected light of the light beam when the light beam crosses a middle of the track, wherein the cycle of the movement of the light beam in the track set is coincident with a cycle of one-channel bit length of a recording code to be recorded in a tracking direction.

An optical reproduction apparatus according to another aspect of the invention comprises a mover for cyclically moving a light beam in a track set with a predetermined pattern, the track set being constituted of adjacent tracks of a predetermined number; and a reproducer for reproducing data recorded in the track set by sampling a reproduction signal to be generated in receiving reflected light of the light beam when the light beam crosses a middle of the track, wherein the cycle of the movement of the light beam in the track set is coincident with a cycle of one-channel bit length of a recording code to be recorded in a tracking direction.

An optical recording medium according to another aspect of the invention comprises a plurality of tracks; and a recording layer, wherein the adjacent tracks of a predetermined number constitute a track set, and the middle track or the two middle tracks of the track set is or are wobbled at a predetermined amplitude and at a predetermined cycle.

An optical recording medium according to another aspect of the invention comprises a plurality of tracks; and a recording layer, wherein the adjacent tracks of a predetermined number constitute a track set, and an interval between the track sets adjacent to each other is set wider than an interval between the tracks of each of the track sets.

An optical recording medium according to another aspect of the invention comprises a track; and a plurality of recording layers, wherein the track is formed in a farthest layer, of the recording layers, from an incident surface of a light beam, the farthest layer having a structure identical to a structure of any one of the aforementioned optical recording media.

A tracking control method according to another aspect of the invention comprises a first step of performing a tracking control with respect to a middle track of a track set, the track set being constituted of adjacent tracks of a predetermined number; a second step of controlling a light beam to be cyclically moved with a predetermined magnitude of amplitude, with a middle of the middle track of the track set being defined as a center of a trajectory of the light beam; a third step of controlling the light beam to be cyclically moved in the track set with a predetermined cycle; and a fourth step of controlling the light beam to be cyclically moved in the track set with a predetermined phase corresponding to a predetermined position of the track set.

A tracking control circuit according to another aspect of the invention comprises a tracking controller for performing a tracking control with respect to a middle track of a track set, the track set being constituted of adjacent tracks of a predetermined number; an amplitude controller for controlling a light beam to be cyclically moved with a predetermined magnitude of amplitude, with a middle of the middle track of the track set being defined as a center of a trajectory of the light beam; a cycle controller for controlling the light beam to be cyclically moved in the track set with a predetermined cycle; and a phase controller for controlling the light beam to be cyclically moved in the track set with a predetermined phase corresponding to a predetermined position of the track set.

An optical recording apparatus according to another aspect of the invention comprises a laser; a laser power control circuit for controlling an optical power of laser light to be impulsively outputted from the laser in response to receiving recording data and a tracking middle signal; a collimator lens for collimating the laser light outputted from the laser into parallel light; an EO refractive device for refracting the parallel light collimated by the collimator lens in a radial direction of an optical recording medium, based on a refractive index control signal for cyclically moving the laser light with a predetermined pattern in adjacent tracks of a predetermined number; an objective lens for condensing the parallel light refracted by the EO refractive device to form a focus spot on the track in a recording layer of the optical recording medium; a tracking error detecting circuit for receiving reflected light from the focus spot to output a tracking error signal and the tracking middle signal indicating a middle of the track; a refraction control circuit for receiving the tracking error signal to output the refractive index control signal to the EO refractive device; an amplitude middle error detecting circuit for receiving the tracking error signal to output an amplitude middle error signal obtained by averaging the tracking error signal which has been detected in a predetermined period; and an actuator for driving the objective lens based on the amplitude middle error signal.

An optical reproduction apparatus according to another aspect of the invention comprises a laser; a laser power control circuit for controlling an optical power of laser light to be outputted from the laser to a predetermined value; a collimator lens for collimating the laser light outputted from the laser into parallel light; an EO refractive device for cyclically moving the laser light with a predetermined pattern in adjacent tracks of a predetermined number, and for refracting the parallel light collimated by the collimator lens in a radial direction of an optical recording medium, based on a refractive index control signal to be used in matching a tracking cycle of the laser light with a cycle of one-channel bit length of a recording code to be recorded in a tracking direction; an objective lens for condensing the parallel light refracted by the EO refractive device to form a focus spot on the track in a recording layer of the optical recording medium; an actuator for driving the objective lens; a tracking error detecting circuit for receiving reflected light from the focus spot to output a tracking error signal, a tracking middle signal indicating a middle of the track, and a reproduction signal; a refraction control circuit for receiving the tracking error signal to output the refractive index control signal to the EO refractive device; an amplitude middle error detecting circuit for receiving the tracking error signal to output an amplitude middle error signal obtained by averaging the tracking error signal which has been detected in a predetermined period; an actuator for driving the objective lens based on the amplitude middle error signal; and an analog-to-digital converter for receiving the tracking middle signal and the reproduction signal, and sampling the reproduction signal when the tracking middle signal is asserted to output reproduction data.

An optical recording control circuit according to yet another aspect of the invention comprises a laser power control circuit for controlling an optical power of laser light to be impulsively outputted from a laser in response to receiving recording data and a tracking middle signal; a tracking error detecting circuit for receiving reflected light from a focus spot formed by condensing laser light refracted by an EO refractive device on a track in a recording layer of an optical recording medium through an objective lens to output a tracking error signal and a tracking middle signal indicating a middle of the track; a refraction control circuit for receiving the tracking error signal to output, to the EO refractive device, a refractive index control signal to be used in cyclically moving the laser light with a predetermined pattern in adjacent tracks of a predetermined number; and an amplitude middle error detecting circuit for receiving the tracking error signal to output an amplitude middle error signal obtained by averaging the tracking error signal which has been detected in a predetermined period to an actuator for driving the objective lens.

An optical reproduction control circuit according to still another aspect of the invention comprises a laser power control circuit for controlling an optical power of laser light to be outputted from a laser to a predetermined value; a tracking error detecting circuit for receiving reflected light from a focus spot formed by condensing the laser light refracted by an EO refractive device on a track in a recording layer of an optical recording medium through an objective lens to output a tracking error signal, a tracking middle signal indicating a middle of the track, and a reproduction signal; a refraction control circuit for receiving the tracking error signal to cyclically move the laser light with a predetermined pattern in adjacent tracks of a predetermined number, and for outputting, to the EO refractive device, a refractive index control signal to be used in matching a tracking cycle of the laser light with a cycle of one-channel bit length of a recording code to be recorded in a tracking direction; an amplitude middle error detecting circuit for receiving the tracking error signal to output an amplitude middle error signal obtained by averaging the tracking error signal which has been detected in a predetermined period to an actuator for driving the objective lens; and an analog-to-digital converter for receiving the tracking middle signal and the reproduction signal, and sampling the reproduction signal when the tracking middle signal is asserted to output reproduction data.

According to the invention, a time required for data recording can be shortened by recording data while impulsively controlling the power of the light beam when the light beam crosses the middle of each of the adjacent tracks of the predetermined number, thereby enabling to increase the data transfer rate.

These and other objects, features and advantages of the present invention will become more apparent upon reading of the following detailed description along with the accompanying drawings.

### BRIEF DESCRIPTION OF THE DRAWINGS

FIG. 1 is a diagram for describing an optical recording method embodying the invention.

FIG. 2 is a diagram for describing the optical recording method shown in FIG. 1 in detail.

FIG. 3 is a diagram for describing another optical recording method embodying the invention.

FIG. 4 is a diagram for describing the optical recording method shown in FIG. 3 in detail.

FIG. 5 is a diagram for describing an optical reproduction method embodying the invention.

FIGS. 6A through 6D are diagrams for describing a tracking control method embodying the invention.

FIGS. 7A through 7C are diagrams for describing center position control with respect to a trajectory of a light beam when the light beam is moved within a set of tracks.

FIGS. 8A through 8C are diagrams for describing tracking amplitude control when the light beam is moved within the track set.

FIG. 9 is a diagram for describing tracking cycle control when the light beam is moved within the track set.

FIG. 10 is a diagram for describing phase control with respect to the trajectory of the light beam when the light beam is moved within the track set.

FIG. 11 is a diagram for describing phase control with respect to the trajectory of the light beam when the light beam is moved within the track set in a state that a pit is formed in the middle track of the track set.

FIGS. 12A through 12C are diagrams for describing a track configuration of an optical recording medium embodying the invention.

FIG. 13 is a diagram showing a track configuration of an optical recording medium as a third modification of the embodiment.

FIG. 14 is a block diagram showing a configuration of an optical recording/reproducing apparatus embodying the invention.

FIGS. 15A and 15B are diagrams for describing an operation of an EO refractive device shown in FIG. 14.

FIGS. 16A and 16B are diagrams for describing an amplitude detecting circuit shown in FIG. 14.

FIG. 17 is a block diagram showing a configuration of a pit phase detecting circuit shown in FIG. 14.

FIG. 18 is a diagram showing an arrangement of a reference pit in an optical recording medium.

### BEST MODE FOR CARRYING OUT THE INVENTION

In the following, a best mode for carrying out the invention will be described referring to the drawings.

An optical recording method embodying the invention is a method for recording data in plural tracks, wherein an odd number of adjacent tracks are defined as a set of tracks (hereinafter, the set of tracks is also called as “track set”), a light beam is cyclically moved within the track set, and the power of the light beam is impulsively increased when the light beam crosses the middle of the track of the track set. In this operation, the cycle (hereinafter, called as “tracking cycle”) at which the light beam is moved within the tracks is set to one-channel bit length of a recording code to be recorded in the tracking direction.

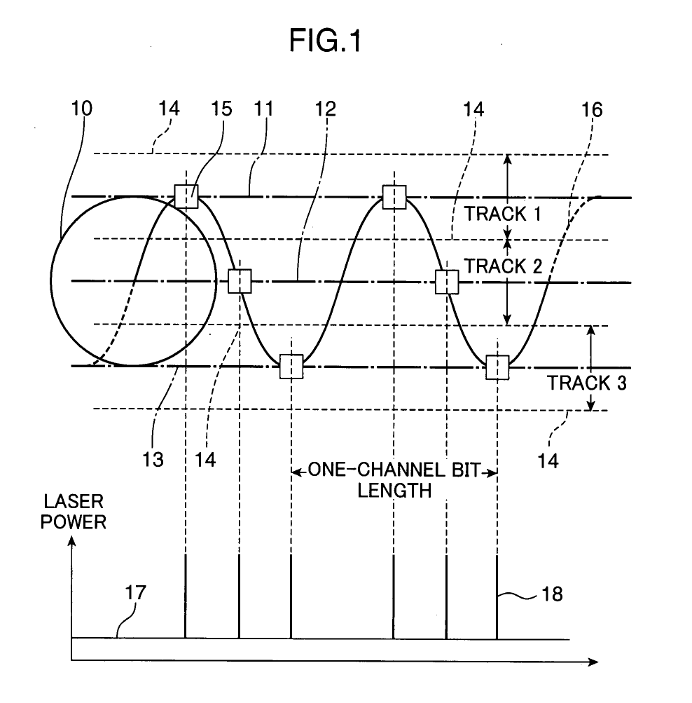

FIG. 1 is a diagram for describing the optical recording method embodying the invention. FIG. 1 shows an example, in which three tracks are defined as a set of tracks (track set), and a light beam is cyclically moved within the three tracks to record data in the three tracks. The upper section in FIG. 1 shows a movement of the light beam on a recording medium, and the lower section in FIG. 1 shows a change of the laser power in recording.

The square marks 15 in FIG. 1 each indicates a timing at which data is to be recorded or a timing at which reproduction light is to be sampled by controlling the power of the light beam so that the light beam is irradiated impulsively. The one-dot chain lines in FIG. 1 indicate middles 11, 12, and 13 of the respective tracks 1, 2, and 3, and the broken lines in FIG. 1 indicate boundaries 14 between the tracks 1 and 2, and 2 and 3.

A beam spot 10 is moved along a cyclic trajectory as shown by a light beam trajectory 16, and is moved within the three tracks adjacent to each other i.e. the tracks 1, 2, and 3. As shown in FIG. 1, the light beam trajectory 16 has a sinusoidal waveform.

The light beam trajectory 16 is moved between the middle 11 of the track 1, and the middle 13 of the track 3, with the middle 12 of the track 2 being defined as the center of the light beam trajectory 16. The middle 11 of the track 1 and the middle 13 of the track 3 are control targets for position control of the beam spot 10. Data is recorded by impulsively increasing the optical power of the beam spot 10 when the beam spot 10 crosses the middle 11 of the track 1, the middle 12 of the track 2, and the middle 13 of the track 3. As shown in the lower section of FIG. 1, whereas the beam spot 10 is irradiated with a significantly weak reproduction laser power 17 when the beam spot 10 is moved in areas of the tracks 1, 2, and 3 other than the middles 11, 12, and 13, the beam spot 10 is irradiated with a significantly strong recording laser power 18 of an extremely short impulse when the beam spot 10 crosses the middles 11, 12, and 13 of the tracks 1, 2 and 3, respectively.

The impulse width of the light beam in recording is set to one-half of a division (time) obtained by dividing an allowable tracking error by a relative speed of the light beam to the track, or less. In other words, assuming that the allowable tracking error is T, and the relative speed of the light beam to the track is V, the impulse width I of the light beam can be expressed by the following formula (I).

I≦T/2V (1)

Here, the allowable tracking error T is an allowable distance error by which the center of the light beam in recording is allowed to be distanced from the middle of the track. If the control error of the light beam is equal to or smaller than the allowable distance error, data is recorded with jitter within an allowable range. The value of the allowable range differs depending on a margin distribution of a system. For instance, assuming that the allowable tracking error T is 10 nm, and the relative speed V of the light beam to the track is 100 m/sec, the impulse width I is 50 psec.

The data is recorded in the tracks independently of each other in the form of a predetermined recording code. The cycle of the light beam trajectory 16 is set to one-channel bit length of the recording code. Accordingly, the cycle for making the optical power of the beam spot 10 into an impulse is also set to one-channel bit length.

As shown in FIG. 1, in the case where the beam spot 10 is moved within the odd number of tracks (in FIG. 1, three tracks), the above arrangement enables to easily detect and correct a displacement of the beam movement, because the middle track of the track set is coincident with the center of the beam movement. Thereby, recording with less jitter can be performed.

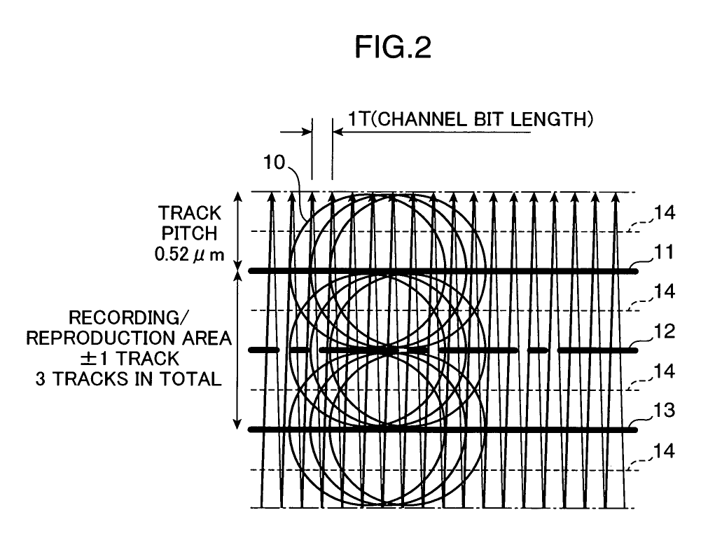

In FIG. 1, the cycle of the movement of the light beam is set long for sake of easy explanation. Actually, however, the cycle of the movement of the light beam to be moved is short. FIG. 2 is a diagram for describing the optical recording method shown in FIG. 1 in detail. Referring to FIG. 2, the diameter of the beam spot 10 is 474 nm, the track pitch is 0.52 μm, and the one-channel bit length (T) is 121.4 nm. Accordingly, the beam spots 10 are disposed one over the other, with the centers thereof being close to each other.

In this way, data is recorded in the track set by impulsively controlling the power of the light beam with the predetermined intensity when the light beam is cyclically moved with the predetermined pattern within the track set, the predetermined number of adjacent tracks being defined as the track set, and the light beam crosses the middle of each of the tracks.

Thus, the time required for data recording can be shortened by recording the data while controlling the power of the light beam so that the light beam is impulsively irradiated when the light beam crosses the middle of each of the adjacent tracks of the predetermined number, thereby enabling to increase the data transfer rate.

The cycle of the movement of the light beam within the track set is coincident with the cycle of one-channel bit length of the recording code to be recorded in the tracking direction. Thus, the data can be recorded with a high density by recording the data while controlling the power of the light beam so that the light beam is impulsively irradiated when the light beam is cyclically moved within the one-channel bit length, and the light beam crosses the middle of the track.

Also, the trajectory of the light beam to be moved within the track set has a sinusoidal waveform. Accordingly, the light beam can be easily moved by controlling the amplitude, the frequency, and the phase of the trajectory of the light beam. In this embodiment, the light beam is so controlled that the trajectory of the light beam has the sinusoidal waveform. Alternatively, the light beam may be controlled so that the trajectory of the light beam has a triangular waveform.

Next, an optical reproduction method embodying the invention is described referring to FIG. 1. Similarly to the recording time, in a reproduction time, the beam spot 10 is cyclically moved within the track set. When the beam spot 10 crosses the middle of the track, a reproduction signal, i.e. an electric signal which is converted from the reflected light of the beam spot 10 is sampled. Thereby, the data that has been recorded in the tracks independently of each other in the form of the predetermined recording code is reproduced. The cycle of the light beam trajectory 16 is set to one-channel bit length of the recording code. Accordingly, the sampling cycle of the reproduction signal to be generated based on the reflected light of the beam spot 10 is also set to one-channel bit length. Thus, the reproduction signal to be generated based on the reflected light of the beam spot 10 is sampled at the same timing when data has been recorded by impulsively increasing the optical power of the beam spot 10 by the aforementioned optical recording method.

As described above, the data recorded in the track set is reproduced by sampling the reproduction signal to be generated by receiving the reflected light of the light beam when the light beam is cyclically moved with the predetermined pattern within the track set, the predetermined number of adjacent tracks being defined as the track set, and the light beam crosses the middle of the track. The cycle of the movement of the light beam within the track set is coincident with the cycle of the one-channel bit length of the recording code to be recorded in the tracking direction.

Accordingly, the data recorded with a high density can be reproduced by reproducing the data while controlling the reproduction power of the light beam when the light beam is cyclically moved within the one-channel bit length, and the light beam crosses the middle of the track.

Also, in the case where the track set is constituted of an odd number of tracks, and the light beam is moved within the odd number of tracks, the above arrangement enables to easily detect and correct a displacement of the beam movement, because the middle track of the track set is coincident with the center of the beam movement. Thereby, reproduction with less jitter can be performed.

Furthermore, the data recorded in the track other than the outermost tracks of the track set is reproduced by sampling the reproduction signal to be generated by receiving the reflected light of the light beam when the light beam crosses the middle of the track other than the outermost tracks of the track set. This enables to reproduce data in a straight portion of the beam movement i.e. a portion where the beam spot trajectory is most stabilized to thereby reduce jitter in reproduction.

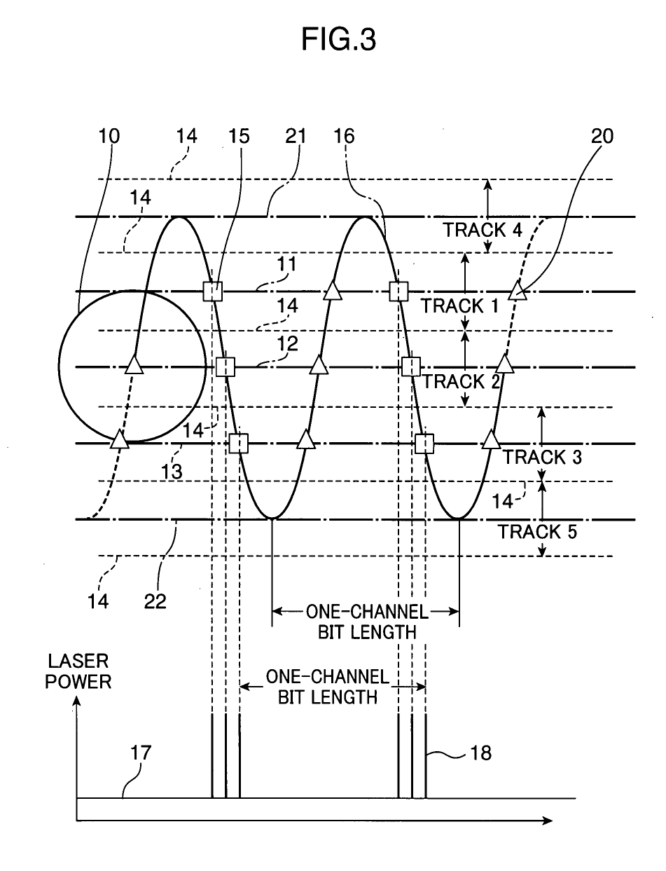

Next, another optical recording method embodying the invention is described. FIG. 3 is a diagram for describing the optical recording method embodying the invention. FIG. 3 shows an example, in which five tracks are defined as a track set, and data is recorded in or reproduced from three tracks of the track set, while the light beam is cyclically moved within the five tracks. The upper section in FIG. 3 shows a movement of the light beam on a recording medium, and the lower section in FIG. 3 shows a change of the laser power in recording.

The square marks 15 in FIG. 3 each indicates a timing at which data is to be recorded or a timing at which reproduction light is to be sampled by impulsively controlling the power of the light beam. The triangular marks 20 in FIG. 3 each indicates a timing at which the reproduction light is sampled. The one-dot chain lines in FIG. 3 indicate middles 11, 12, 13, 21, and 22 of the respective tracks 1, 2, 3, 4, and 5, and the broken lines in FIG. 3 indicate boundaries 14 between the tracks 1 and 2, 2 and 3, 3 and 4, and 4 and 5.

A beam spot 10 is moved along a cyclic trajectory as shown by a light beam trajectory 16, and is moved within the five tracks adjacent to each other i.e. the tracks 1, 2, 3, 4, and 5. As shown in FIG. 3, the light beam trajectory 16 has a sinusoidal waveform.

The light beam trajectory 16 is moved between the middle 21 of the track 4, and the middle 22 of the track 5, with the middle 12 of the track 2 being defined as the center of the light beam trajectory 16. The middle 21 of the track 4 and the middle 22 of the track 5 serve as controls targets for position control of the beam spot 10. Data is recorded by impulsively increasing the optical power of the beam spot 10 when the beam spot 10 crosses the middle 11 of the track 1, the middle 12 of the track 2, and the middle 13 of the track 3. As shown in the lower section of FIG. 3, whereas the beam spot 10 is irradiated with a significantly weak reproduction laser power 17 when the beam spot 10 is moved in areas of the tracks 1 through 5 other than the middles 11, 12, and 13 of the tracks 1, 2, and 3, the beam spot 10 is irradiated with a significantly strong recording laser power 18 of an extremely short impulse when the beam spot 10 crosses the middles 11, 12, and 13 of the tracks 1, 2, and 3. The impulse width of the light beam in recording is the same as mentioned above.

The data is recorded in the tracks independently of each other in the form of a predetermined recording code. The cycle of the light beam trajectory 16 is set to one-channel bit length of the recording code. Accordingly, the cycle for making the optical power of the beam spot 10 into an impulse is also set to one-channel bit length.

In the example of FIG. 3, recording is performed in the range from 90-degree phase to 270-degree phase of the cycle of the light beam trajectory 16, and reproduction is performed in the range from 270-degree phase to 90-degree phase. In other words, the power of the beam spot 10 is set to the reproduction power in the range from 270-degree phase to 90-degree phase, and the reproduction power is converted into the reproduction signal by receiving reflected light of the beam spot 10. Thus, the data recorded in the range from 90-degree phase to 270-degree phase can be reproduced by sampling the reproduction signal when the beam spot 10 crosses the middle 11 of the track 1, the middle 12 of the track 2, and the middle 13 of the track 3.

As mentioned above, the data recorded in the range from 90-degree phase to 270-degree phase can be verified to have the predetermined configuration by performing a proper signal processing such as partial response equalization, based on the reproduction signal to be generated when the cycle of the movement of the light beam is in the range from 270-degree phase to 90-degree phase. Thus, by recording and reproducing data within one cycle, the recorded data (marks and spaces) can be verified on a real-time basis, which enables to enhance recording reliability.

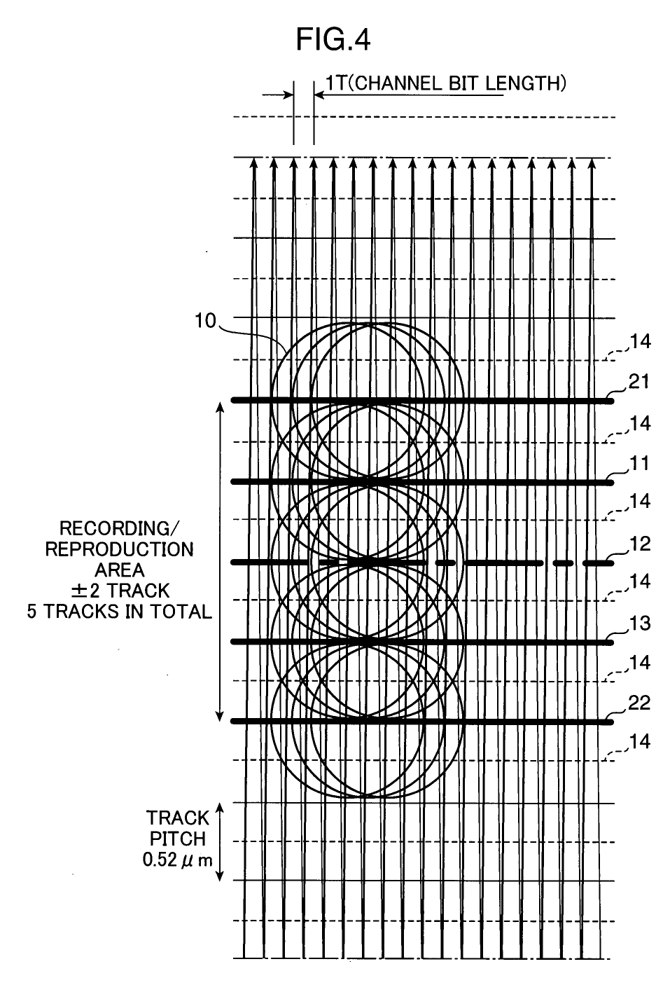

In FIG. 3, the cycle of the movement of the light beam is set long for sake of easy explanation. Actually, however, the cycle of the movement of the light beam is short. FIG. 4 is a diagram for describing the optical recording method shown in FIG. 3 in detail. Referring to FIG. 4, the radius of the beam spot 10 is 474 nm, the track pitch is 0.52 μm, and the one-channel bit length (T) is 121.4 nm. Accordingly, the beam spots 10 are disposed one over the other, with the centers thereof being close to each other. Accordingly, the data recorded in the range from 90-degree phase to 270-degree phase can be reproduced in the range from 270-degree phase to 90-degree phase.

The difference between the optical recording methods shown in FIGS. 1 and 3 is that, in the optical recording method shown in FIG. 3, data is recorded in the track other than the outermost tracks, without recording data in peaks and valleys of the light beam trajectory 16 i.e. the outermost tracks of the track set. This enables to record and reproduce data within one cycle. Also, the linear velocity of the beam spot 10 to the recording layer with respect to the track 4 and the track 5 is considerably slower than the linear velocity of the beam spot 10 when the beam spot 10 crosses the middle 11 of the track 1, the middle 12 of the track 2, and the middle 13 of the track 3. Accordingly, the recording in the track 4 and the track 5 is greatly affected by a change in linear velocity, which makes it difficult to realize stable recording. Contrary to this, since the linear velocities of the beam spot 10 when the beam spot 10 crosses the middle 11 of the track 1, the middle 12 of the track 2, and the middle 13 of the track 3 are substantially identical to each other, stable recording can be facilitated.

Alternatively, recording may be performed twice in the range from 90-degree phase to 270-degree phase, and in the range from 270-degree phase to 90-degree phase. The twice recording within one cycle (within one channel bit length of the recording code) enables to secure more accurate recording.

In this embodiment, in data recording, data is recorded in the range from 90-degree phase to 270-degree phase, and data is reproduced in the range from 270-degree phase to 90-degree phase. Alternatively, in data reproduction, data may be reproduced in the range from 90-degree phase to 270-degree phase, and may be reproduced again in the range from 270-degree phase to 90-degree phase.

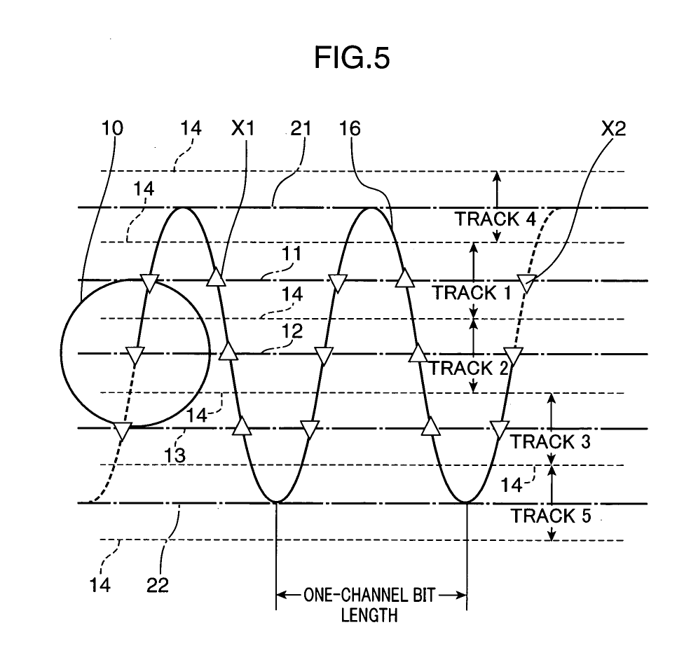

FIG. 5 is a diagram for describing another optical reproduction method embodying the invention. FIG. 5 shows an example, in which five tracks are defined as a set of tracks, the light beam is cyclically moved within the five tracks, and data is reproduced from three tracks of the track set.

The beam spot 10 is moved along a cyclic trajectory as shown by the light beam trajectory 16, and is moved within the five tracks adjacent to each other i.e. the track 1, the track 2, the track 3, the track 4, and the track 5 with a reproduction power. As shown in FIG. 5, the light beam trajectory 16 has a sinusoidal waveform.

The light beam trajectory 16 is moved between the middle 21 of the track 4 and the middle 22 of the track 5, with the middle 12 of the track 2 being defined as the center of the light beam trajectory 16. The middle 21 of the track 4 and the middle 22 of the track 5 serve as control targets for position control of the beam spot 10. The cycle of the light beam trajectory 16 is set to one-channel bit length of the recording code. The reflected light from the beam spot 10 is received by a sensor, and converted into a reproduction signal.

The triangular marks X1 and the inverse triangular marks X2 in FIG. 5 each shows a timing when the reproduction signal is sampled. Data recorded in the track 1, the track 2, and the track 3 are reproduced by sampling the reproduction signal when the beam spot 10 crosses the middle 11 of the track 1, the middle 12 of the track 2, and the middle 13 of the track 3.

In the example of FIG. 5, the reproduction signal is sampled from the track 1, the track 2, and the track 3 in the range from 90-degree phase to 270-degree phase of the cycle of the light beam trajectory 16, and the reproduction signal is sampled again from the track 1, the track 2, and the track 3 in the range from 270-degree phase to 90-degree phase. In other words, the reproduction signal is sampled from the tracks 1 through 3 twice in the range from 90-degree phase to 270-degree phase, and in the range from 270-degree phase to 90-degree phase. Thus, the reproduction reliability can be enhanced by sampling the reproduction signal multiple times in one-channel bit length.

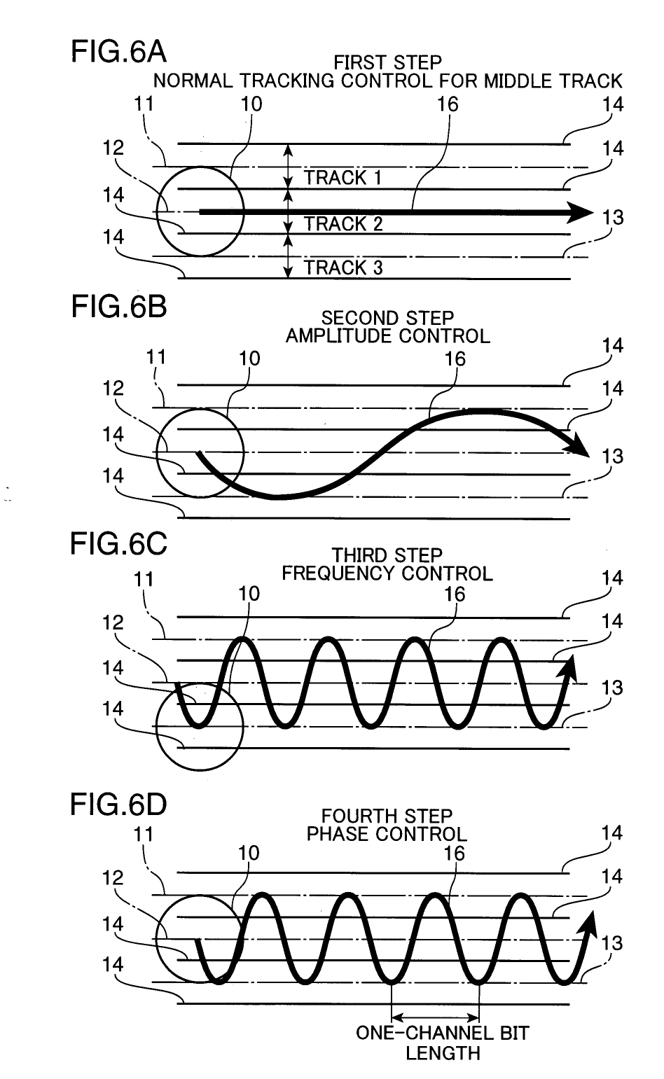

Next, a tracking control method embodying the invention is described. FIGS. 6A through 6D are diagrams for describing a tracking control method embodying the invention. FIG. 6A is a diagram showing a first step of the tracking control method, FIG. 6B is a diagram showing a second step of the tracking control method, FIG. 6C is a diagram showing a third step of the tracking control method, and FIG. 6D is a diagram showing a fourth step of the tracking control method. In FIGS. 6A through 6D, similarly to FIG. 1, three tracks are defined as a set of tracks.

In the first step shown in FIG. 6A, the beam spot 10 is kept unmoved in a direction perpendicular to the tracking direction, and tracking control is performed with respect to the middle track 2 of the track set in a similar manner as tracking control is performed with respect to an ordinary optical disk. When the control error in the first step is converged to a predetermined value or less, amplitude control in the second step is performed together with the tracking control in the first step.

In the second step shown in FIG. 6B, the amplitude (hereinafter, called as “tracking amplitude”) of the beam spot 10 is controlled in such a manner that the beam spot 10 is cyclically moved within the track 1, the track 2, and the track 3, in other words, amplitude control is performed. In this embodiment, the amplitude control is performed in such a manner that the trajectory of the beam spot 10 has a sinusoidal waveform. The middle 11 of the track 1 and the middle 14 of the track 3 serve as targets for the amplitude control. The trajectory 16 of the beam spot 10 is controlled in such a manner that a peak of the trajectory 16 of the beam spot 10 is coincident with the middle 11 of the track 1, and that a valley of the trajectory 16 is coincident with the middle 13 of the track 3. The tracking control in the first step is performed simultaneously with the amplitude control. Accordingly, the beam spot 10 is cyclically moved within the three tracks 1, 2, and 3, with the middle track 2 being defined as the center of the trajectory 16.

In the third step shown in FIG. 6C, the cycle (frequency) of the movement of the beam spot 10 within the track set (in the example of FIG. 6C, three tracks) is controlled. In the optical recording method embodying the invention, data is recorded in the tracks independently of each other in the form of a predetermined recording code. The cycle of the movement of the beam spot 10 within the track set is controlled to be equal to one-channel bit length of the recording code.

In the fourth step shown in FIG. 6D, the cycle of the movement of the beam spot 10 within the track set is identical to that in the third step. However, the cycle of the trajectory 16 is controlled to be coincident with a predetermined phase corresponding to a predetermined position on the track.

As mentioned above, the predetermined number of adjacent tracks are defined as a set of tracks, tracking control is performed with respect to the middle track of the track set, and the amplitude of the cyclic movement of the light beam is controlled to have the predetermined magnitude, with the middle of the middle track of the track set being defined as the center of the amplitude control. The cycle of the movement of the light beam which is cyclically moved within the track set is controlled to be coincident with the predetermined cycle, and the phase of the movement of the light beam which is cyclically moved within the track set is controlled to be coincident with the predetermined phase corresponding to the predetermined position within the track set.

In the above arrangement, first, the tracking control is performed with respect to the middle track of the track set. Then, the amplitude of the light beam is controlled, and the cycle of the movement of the light beam is controlled. Subsequently, the phase of the light beam is controlled. Thus, the light beam can be moved with a sinusoidal wave pattern by conducting the aforementioned operations.

In the following, the processes from the first step through the fourth step will be described in detail.

In the second step, the center position control with respect to the light beam trajectory when the light beam is moved within the track set is performed. By sampling a tracking error signal when the light beam is in a neutral position, in other words, when the light beam trajectory is in the ree phase position and in the 180-degree phase position, which are the same control positions as in the first step, a displacement between a center position of the trajectory of the light beam which is cyclically moved within the track set, and the middle track of the track set is detected. Then, the center position with respect to the light beam trajectory is performed in such a manner that the center position of the trajectory of the light beam which is cyclically moved within the track set is coincident with the middle track.

In the second step, the average position of the light beam i.e. the displacement between the center position of the trajectory of the light beam which is cyclically moved within the track set, and the middle track may be detected by integrating the tracking error signal by a predetermined time constant to make the center position of the trajectory of the light beam which is cyclically moved within the track set coincident with the middle track.

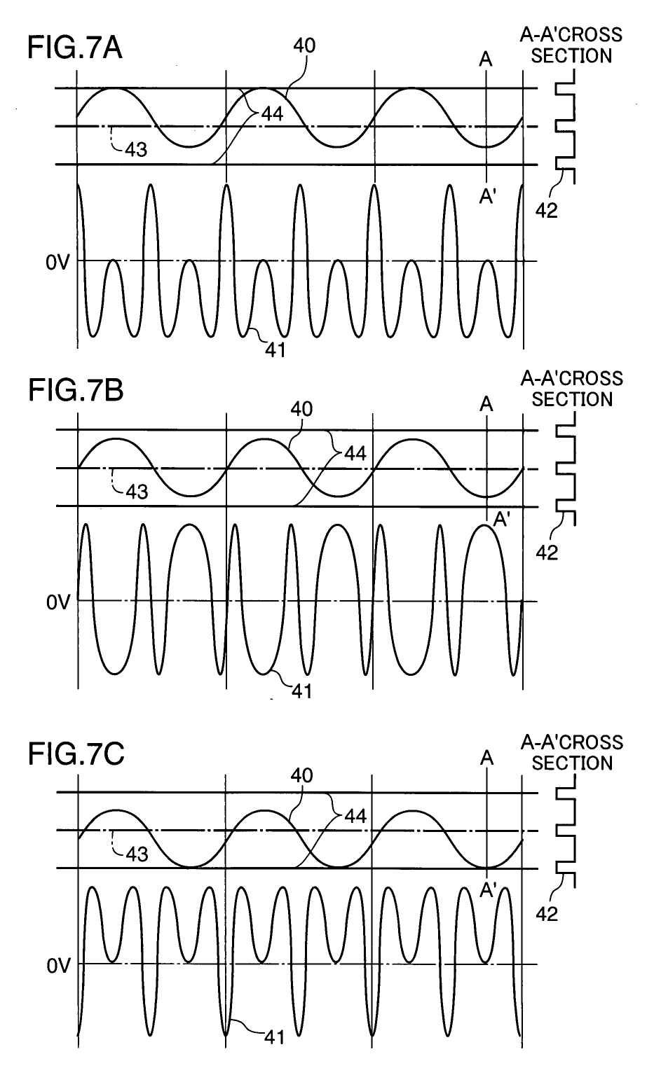

FIGS. 7A through 7C are diagrams for describing the center position control with respect to the light beam trajectory when the light beam is moved within the track set. FIGS. 7A through 7C show light beam trajectories and tracking error signals in the case where the center position of the light beam trajectory is displaced when the light beam is moved within the track set. FIG. 7A is a diagram showing a case that the light beam is displaced upwardly. FIG. 7B is a diagram showing a case that the center of the light beam trajectory lies on the middle track. FIG. 7C is a diagram showing a case that the light beam is displaced downwardly. The upper sections in FIGS. 7A through 7C show the light beam trajectories, and the lower sections in FIGS. 7A through 7C show the tracking error signals.

As shown in FIG. 7B, in the case where the light beam trajectory 40 is moved, with a middle track 43 being defined as the center of the light beam trajectory 40, tracking error signal components in the first half cycle and in the latter half cycle of the light beam trajectory 40 are symmetrical with respect to 0V. As shown in FIGS. 7A and 7C, in the case where the center of the light beam trajectory 40 is displaced from the middle track 43, tracking error signal components in the first half cycle and in the latter half cycle of the light beam trajectory 40 are identical to each other.

Accordingly, by integrating the tracking error signal in one cycle of the light beam trajectory 40, the integration value to be obtained in the case where the light beam trajectory 40 is moved, with the middle track 43 being defined as the center of the light beam trajectory 40 becomes zero; and the integration value to be obtained in the case where the light beam trajectory 40 is displaced from the middle track 43 becomes a value other than zero. The signal obtained by integrating the tracking error signal in a proper period is detected as a displacement amount of the light beam trajectory 40 when the light beam is cyclically moved within the track set with respect to the middle track 43. Thus, the center position of the light beam trajectory 40 is controlled to be coincident with the middle track 43. Also, the tracking error signal at the 0-degree phase and the 180-degree phase of the light beam trajectory 40 can be detected as a displacement amount of the center position of the light beam trajectory 40 when the light beam is cyclically moved within the track set with respect to the middle track 43. Thus, the center position of the light beam trajectory 40 is controlled to be coincident with the middle track 43.

In this way, the center position control with respect to the movement of the light beam is performed by detecting the tracking error signal at the 0-degree phase and the 180-degree phase of the cycle of the movement of the light beam which is cyclically moved within the track set, as a displacement between the middle of the middle track of the track set, and the center of the cyclic movement of the light beam.

Accordingly, a displacement between the middle track and the center of the cyclic movement of the light beam can be detected by detecting the tracking error signal at the 0-degree phase and the 180-degree phase of the cycle of the movement of the light beam i.e. when the light beam crosses the middle track of the track set. Thus, the center position control with respect to the movement of the light beam can be performed based on the tracking error signal.

Also, the center position control with respect to the movement of the light beam is performed by detecting a tracking error signal integrated with a proper time constant, as a displacement between the middle of the middle track of the track set, and the center of the cyclic movement of the light beam. Accordingly, the average position of the light beam i.e. a displacement between the center position of the trajectory of the light beam which is cyclically moved within the track set, and the middle track can be detected by integrating the tracking error signal with the proper time constant. Thus, the center position of the trajectory of the light beam which is cyclically moved within the track set is controlled to be coincident with the middle track.

Further, in the second step, the tracking amplitude control when the light beam is moved within the track set is performed. Specifically, the number of peaks of the tracking error signal is counted within one cycle of the movement of the light beam which is cyclically moved within the track set, and the amplitude is controlled in such a manner that the counted number of the peaks is coincident with a predetermined number. If the amplitude of the trajectory lies within a predetermined amplitude range, with a targeted amplitude being defined as a center of the amplitude range, the number of the peaks of the tracking error signal is constant. Accordingly, in an approximate amplitude control stage, an approximate amplitude control can be performed by increasing the amplitude when the number of the peaks is smaller than the predetermined number, and by decreasing the amplitude when the number of the peaks is larger than the predetermined number.

Also, it is possible to control the light beam in such a manner that the light beam crosses the middle of an outermost track of the track set by performing the amplitude control in such a manner that tracking error signals at a largest amplitude, in other words, tracking error signals at 90-degree phase and 270-degree phase are identical to each other within one cycle of the movement of the light beam which is cyclically moved within the track set.

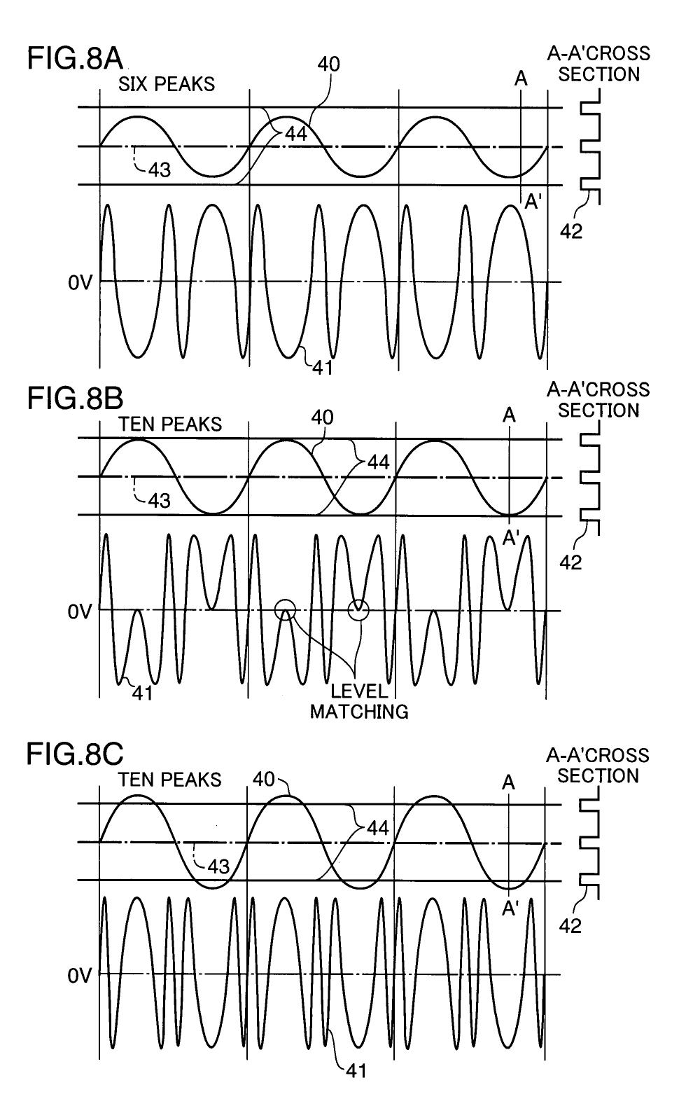

FIGS. 8A through 8C are diagrams for describing the tracking amplitude control when the light beam is moved within the track set. FIGS. 8A through 8C show relations between changes in amplitude of a trajectory of a light beam, and tracking error signals when the light beam is cyclically moved between the upper and the lower tracks, with the middle track being defined as a center of the amplitude control. FIG. 8A is a diagram showing a tracking error signal when the amplitude is so small that the trajectory of the light beam does not reach the outermost track. FIG. 8B is a diagram showing a tracking error signal when the trajectory of the light beam has just reached the outermost track. FIG. 8C is a diagram showing a tracking error signal when the amplitude is so large that the trajectory of the light beam has exceeded the outermost track.

As shown in FIG. 8A, in the case where the amplitude is within an outermost track 44, the number of peaks and valleys of the tracking error signal within one cycle is six. As shown in FIG. 8B, in the case where the amplitude is substantially coincident with the outermost track 44, the number of peaks and valleys of the tracking error signal within one cycle is ten. As shown in FIG. 8C, in the case where the amplitude exceeds the outermost track 44, the number of peaks and valleys of the tracking error signal within one cycle is ten. Accordingly, the movement of the light beam can be controlled in such a manner that the light beam crosses the middle of the outermost track by performing the amplitude control in such a manner that the number of peaks and valleys of the tracking error signal becomes ten within one cycle.

As shown in FIG. 8B, the movement of the light beam can be controlled in such a manner that the light beam crosses the middle of the outermost track by performing amplitude control in such a manner that the level of the tracking error signal at the 90-degree phase position and the level of the tracking error signal at the 270-degree phase position are set identical to each other with respect to 0V within one cycle of the movement of the light beam which is cyclically moved within the track set.

In the third step, tracking cycle control is performed with respect to the light beam which is cyclically moved within the track set. In one cycle of the movement of the light beam which is cyclically moved within the track set having a wobbling middle track, a wobble signal is generated by sampling e.g. a tracking error signal at 0-degree phase and a tracking error signal at 180-degree phase, and by detecting the wobbling of the middle track of the track set. Then, a tracking reference signal is generated by multiplying the wobble signal. Then, a peak-valley detection signal which is inverted each time a peak and a valley of the tracking error signal are detected is generated, and a frequency-divided signal is generated by frequency-dividing the peak-valley detection signal. Then, a displacement between the cycle of the tracking reference signal and the cycle of the frequency-divided signal is detected by comparing the cycles, whereby the cycle control with respect to the light beam trajectory is performed.

Alternatively, the wobble signal may be generated by detecting the wobbling of the middle track of the track set by integrating the tracking error signal to be obtained when the light beam is moved within the track set with a predetermined time constant. The tracking reference signal may be generated by multiplying the wobble signal. In the modification, a peak-valley detection signal which is inverted each time a peak and a valley of the tracking error signal are detected is generated, and a frequency-divided signal is generated by frequency-dividing the peak-valley detection signal. Then, a displacement between the cycle of the tracking reference signal and the cycle of the frequency-divided signal is detected by comparing the cycles, whereby the cycle control with respect to the light beam trajectory is performed.

The cycle of the movement of the light beam within the track set is coincident with the cycle of one-channel bit of the recording code to be recorded in the directions of the respective tracks. Accordingly, the cycle of the movement of the light beam within the track set can be controlled to be coincident with the cycle of one-channel bit of the recording code to be recorded in the directions of the respective tracks by comparing the frequency of the tracking reference signal with the frequency of the frequency-divided signal.

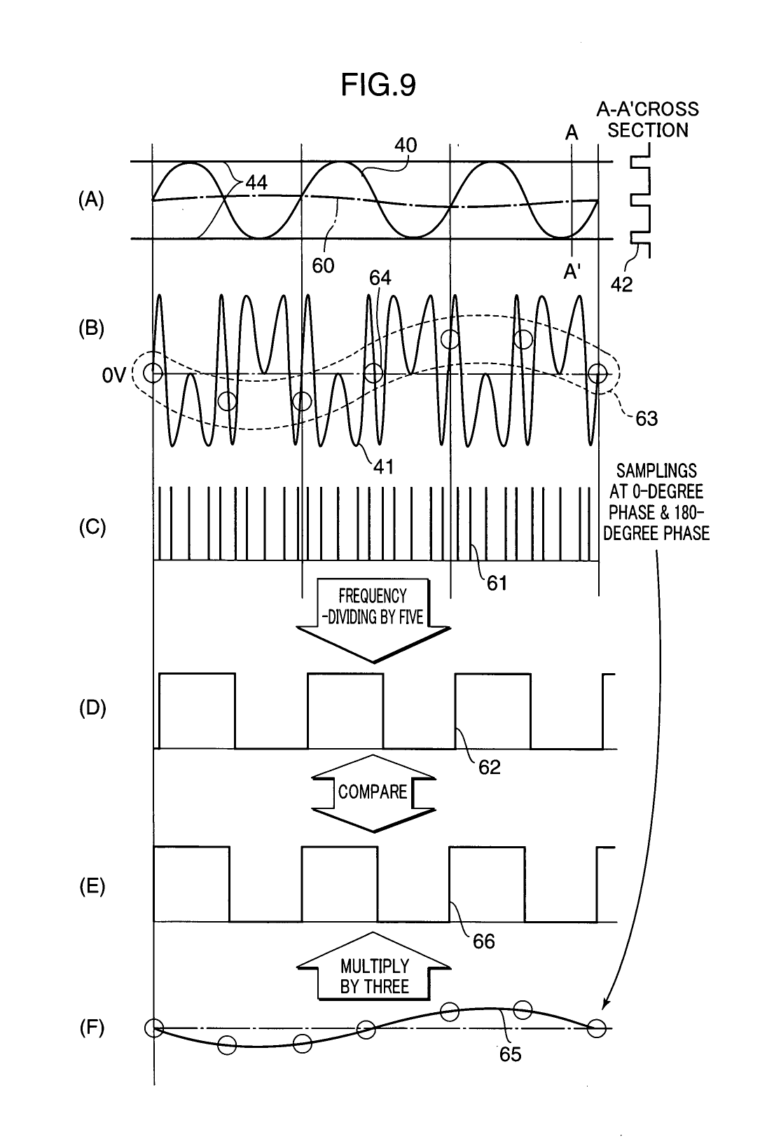

FIG. 9 is a diagram for describing the tracking cycle control to be executed when the light beam is moved within the track set. FIG. 9 shows a tracking cycle control method to be executed when the light beam is cyclically moved within the outermost tracks 44 indicated by the upper and lower tracks, with a wobbling middle track 60 being defined as a center of the light beam trajectory. (A) of FIG. 9 shows a state that the light beam is moved within the three tracks as a track set with a sinusoidal waveform pattern. The middle track 60 of the three tracks is wobbled with a predetermined cycle. The tracking cycle control method in this condition is described in the following.

(B) of FIG. 9 is a diagram showing a tracking error signal to be obtained when the light beam is moved within the track set shown in (A) of FIG. 9. First, peaks and valleys of the tracking error signal 41 are detected. (C) of FIG. 9 is a diagram showing a peak-valley detection signal 61, which is generated by generating a detection pulse of a predetermined length each time a peak or a valley of the tracking error signal is detected. A frequency-divided signal 62 shown in (D) of FIG. 9 is obtained by frequency-dividing the peak-valley detection signal 61 by a predetermined number (in the embodiment, five). The frequency-divided signal 62 corresponds to a cycle signal of the light beam.

Also, a 0-degree/180-degree phase sampling signal 65 shown in (F) of FIG. 9 is obtained by sampling the tracking error signal 41 shown in (B) of FIG. 9 at a timing corresponding to 0-degree phase and at a timing corresponding to 180-degree phase of the tracking cycle of the light beam. The 0-degree/180-degree phase sampling signal 65 shows the wobbling cycle of the wobbling middle track 60. In this embodiment, the wobbling cycle is set to three times as large as the tracking cycle. Thus, a tracking reference signal 66 shown in (E) of FIG. 9 is generated by multiplying the 0-degree/180-degree phase sampling signal 65 by three.

The cycle of the movement of the light beam within the track set can be controlled to be coincident with the cycle of one-channel bit of the recording code to be recorded in the directions of the respective tracks by comparing the frequency of the tracking reference signal 66 with the frequency of the frequency-divided signal 62.

Alternatively, a tracking reference signal equivalent to the aforementioned tracking reference signal can be generated by integrating the tracking error signal 41 with use of an integration circuit having a proper time constant, without sampling the tracking error signal 41 at a predetermined phase. Thus, the tracking cycle of the movement of the light beam within the track set can be controlled, using the tracking reference signal.

In the fourth step, the phase control with respect to the light beam trajectory when the light beam is moved within the track set is performed. Specifically, a wobble signal is generated by sampling a tracking error signal at a predetermined phase of the tracking cycle of the light beam e.g. at 0-degree phase and 180-degree phase, and by detecting the wobbling of the middle track of a track set. Then, a tracking reference signal is generated by multiplying the wobble signal. Then, a peak-valley detection signal which is inverted each time a peak and a valley of the tracking error signal are detected is generated, and a frequency-divided signal is generated by frequency-dividing the peak-valley detection signal. Then, a displacement between the phase of the tracking reference signal and the phase of the frequency-divided signal is detected by comparing the phases, whereby the phase control with respect to the light beam trajectory is performed. Thus, the phase of the movement of the light beam within the track set can be properly controlled by comparing the phase of the tracking reference signal with the phase of the frequency-divided signal.

Alternatively, a wobble signal may be generated by detecting the wobbling of the middle track of the track set by integrating the tracking error signal to be obtained when the light beam is moved within the track set by a predetermined time constant, and a tracking reference signal may be generated by multiplying the wobble signal. In the modification, a peak-valley detection signal which is inverted each time a peak and a valley of the tracking error signal are detected is generated, and a frequency-divided signal is generated by frequency-dividing the peak-valley detection signal. Then, a displacement between the phase of the tracking reference signal and the phase of the frequency-divided signal is detected by comparing the phases, whereby the phase control with respect to the light beam trajectory is performed. Thus, the tracking reference signal equivalent to the aforementioned tracking reference signal can be generated by integrating the tracking error signal with the proper time constant, without sampling the tracking error signal at a predetermined phase. Thus, the phase of the movement of the light beam within the track set can be controlled, using the tracking reference signal.

Alternatively, the phase control with respect to the light beam trajectory may be performed by predefining a reference phase pit at a position displaced by (N+0.5) times (N is an integer) of the cycle of the channel bit length in the two outermost tracks of the track set by PPM (Pit Position Modulation) code, and by making the peak of a reproduction signal to be generated when the light beam crosses the two reference phase pits coincident with the timing at which the tracking amplitude is maximum.

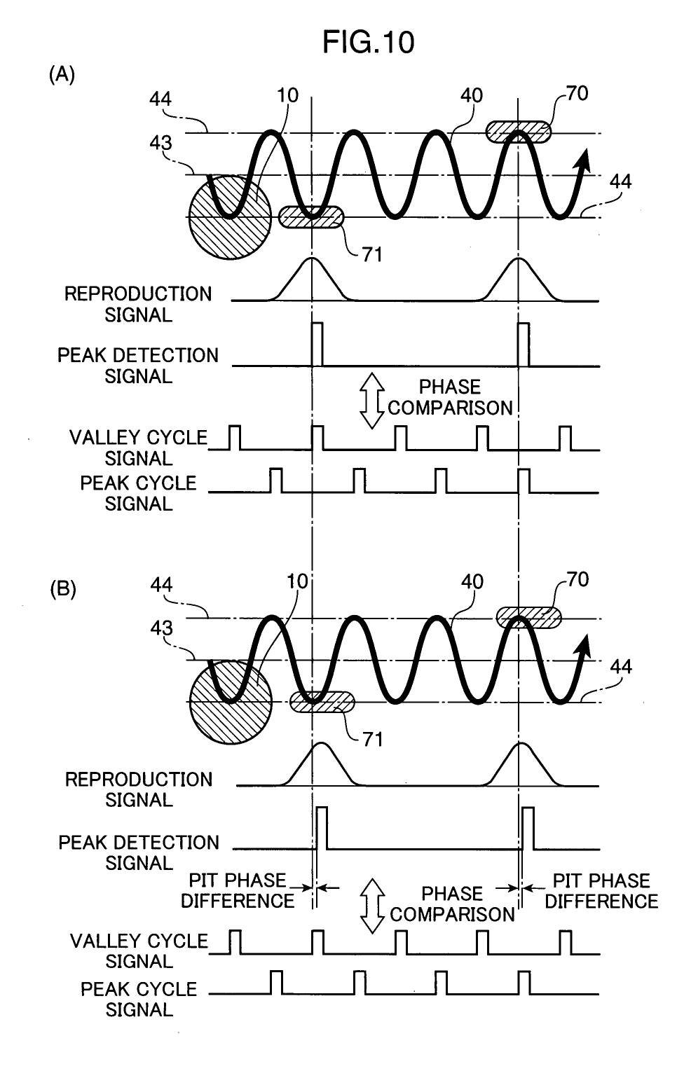

FIG. 10 is a diagram for describing the phase control with respect to the light beam trajectory when the light beam is moved within the track set. FIG. 10 shows the phase control method to be executed when the light beam is cyclically moved within the track set by allowing the light beam to detect the pits 70 and 71 recorded in the outermost tracks 44 by the PPM code.

The upper section in (A) of FIG. 10 shows a state that the phases of the light beam trajectory are coincident with the pits 70 and 71. In this state, the light beam 10 is cyclically moved within the middle track 43 and the outermost tracks 44 at a predetermined amplitude and at a predetermined frequency, with the middle track 43 being defined as a center of the light beam trajectory. When the light beam has reached the pit 70 or the pit 71 recorded in the corresponding outermost track 44 at the predetermined phase, the amplitude of the reproduction signal (see the second section from the uppermost section in (A) of FIG. 10) is increased. The phases of the pits 70 and 71 recorded in the respective corresponding tracks 44 are displaced by (N+0.5) cycle from each other in the tracking cycle. In other words, since the tracking cycle of the light beam is coincident with the cycle of channel bit length in the tracking direction, it may be concluded that the phases of the pits 70 and 71 are displaced by the length of (N+0.5) channel bit.

Then, the peak of the reproduction signal is detected (see the third section from the uppermost section in (A) of FIG. 10), and the phases are compared between the tracking cycle of the light beam and the peak of the reproduction signal. In (A) of FIG. 10, a valley cycle signal indicating a cycle of a valley of the light beam trajectory within the track set, and a peak cycle signal indicating a cycle of a peak of the light beam trajectory are generated (see the fourth and fifth sections from the uppermost section in (A) of FIG. 10). Then, the phase control with respect to the movement of the light beam within the track set is performed by comparing the phases between the peak of the reproduction signal corresponding to the pit 70 which has been detected based on the reproduction signal, and the peak cycle signal, by comparing the phases between the peak of the reproduction signal corresponding to the pit 71, and the valley cycle signal, and by detecting a phase displacement.

(B) of FIG. 10 shows a case that the phase of the light beam trajectory within the track set is displaced from the positions of the pits 70 and 71. In (B) of FIG. 10, the phase of the peak of the reproduction signal is displaced from the phase of the valley cycle signal and from the phase of the peak cycle signal. Accordingly, the phase control is performed by detecting a displacement amount, and by controlling the phase of the movement of the light beam in the track set in such a manner that the phase of a control signal for moving the light beam within the track set is free of a phase displacement.

Thus, the phase of the movement of the light beam can be properly controlled by making the peak of the reproduction signal to be generated when the light beam crosses the outer reference phase pits 70 and 71 formed in the outermost tracks of the track set coincident with the timing at which the amplitude of the light beam is maximum.

Alternatively, the phase control may be performed by predefining a reference phase pit at a predetermined position of the middle track of the track set e.g. at an intermediate position between the two reference phase pits by the PPM code, and by making the peak of the reproduction signal to be generated when the light beam crosses the reference phase pit formed in the middle track coincident with the timing at which the amplitude of the cyclic trajectory of the light beam is zero.

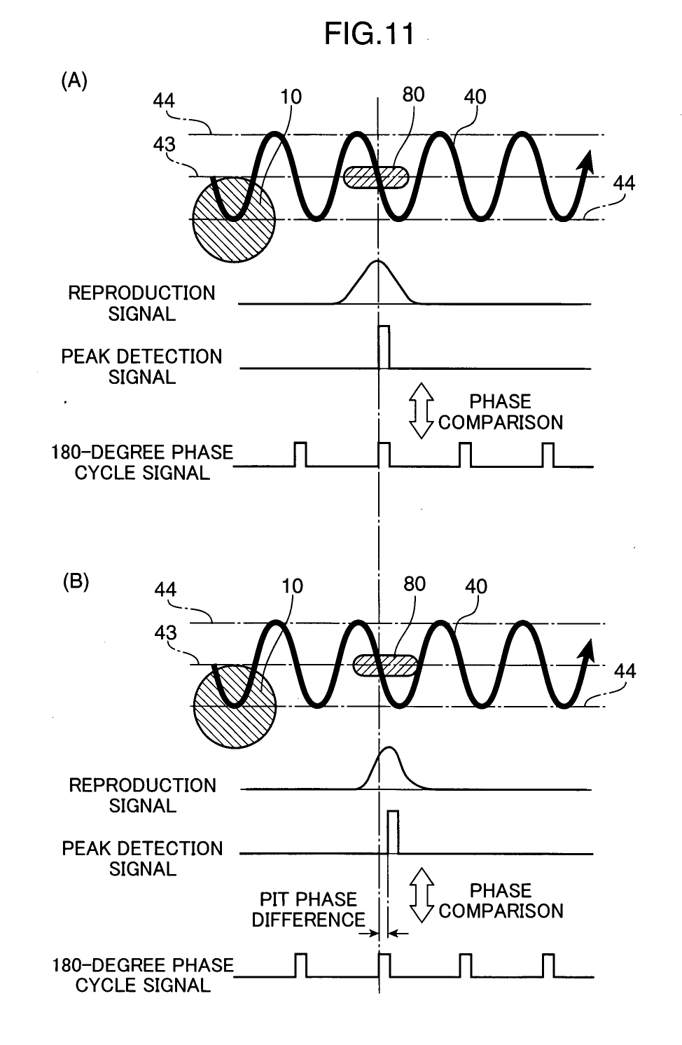

FIG. 11 is a diagram for describing the phase control with respect to the light beam trajectory to be executed when the light beam is moved within a track set, with a pit being formed in the middle track of the track set. FIG. 11 shows a phase control method to be executed when the light beam is cyclically moved within the track set by detecting a pit 80 recorded in the middle track 43 by the PPM code.

The uppermost section in (A) of FIG. 11 shows a state that the phase is coincident with the pit 80. The light beam 10 is cyclically moved within the middle track 43 and the outermost tracks 44 at a predetermined amplitude and at a predetermined frequency, with the middle track 43 being defined as a center of the light beam trajectory. When the light beam has reached the pit 80 recorded in the middle track 43 at the predetermined phase, the amplitude of the reproduction signal (see the second section from the uppermost section in (A) of FIG. 11) is increased. The phase of the pit 80 recorded in the middle track 43 is defined as a reference for 180-degree phase of the cycle of the movement of the light beam within the track set. Also, the phase of the pit 80 is defined as a reference phase of the channel bit in the tracking direction.

The peak of the reproduction signal is detected (see the third section from the uppermost section in (A) of FIG. 11), and the phases are compared between the tracking cycle of the light beam and the peak of the reproduction signal. In (A) of FIG. 11, a 180-degree phase cycle signal indicating the 180-degree phase position of the light beam trajectory within the track set is generated (see the fourth section from the uppermost section in (A) of FIG. 11). Then, the phase of the tracking cycle is controlled by comparing the phases between the peak of the reproduction signal corresponding to the pit 80, which has been detected based on the reproduction signal, and the 180-degree phase cycle signal, and by detecting a phase displacement.

(B) of FIG. 11 shows a case that the phase of the tracking cycle of the light beam is displaced from the position of the pit 80 are displaced from each other. In (B) of FIG. 11, the phase of the peak of the reproduction signal is displaced from the phase of the 180-degree phase cycle signal. Accordingly, the phase control is performed by detecting a displacement amount, and by controlling the phase of the tracking cycle of the light beam in such a manner that the phase of the tracking control signal of the light beam is free of a phase displacement.

Thus, the phase of the movement of the light beam can be properly controlled by making the peak of the reproduction signal to be generated when the light beam crosses the middle reference phase pit 80 formed in the middle track of the track set coincident with the timing corresponding to 0-degree phase or 180-degree phase of the cycle of the movement of the light beam.

In the first step, alternatively, a wobbling frequency and a wobbling phase, or a frequency and a phase of the middle reference phase pit 80 recorded in the middle track may be detected in a state that the control error is converged in a predetermined range by performing a tracking control with respect to the middle track of the track set; and a tracking control signal to be used in an initial stage of the second step may be generated based on the detected wobbling frequency and the detected wobbling phase, or the detected cycle and the detected phase of the middle reference phase pit 80.

In the modification, in the case where the middle track 43 is wobbled, or in the case where the middle reference phase pit 80 is recorded in the middle track 43 as shown in (A) of FIG. 11, the control time can be shortened by generating a tracking control signal for controlling the phase of the tracking cycle of the light beam, by making the frequency and the phase of the tracking control signal coincident with those of the wobbling track or the middle reference phase pit 80, and by using the tracking control signal as an initial signal to be used in performing the amplitude control in the second step.

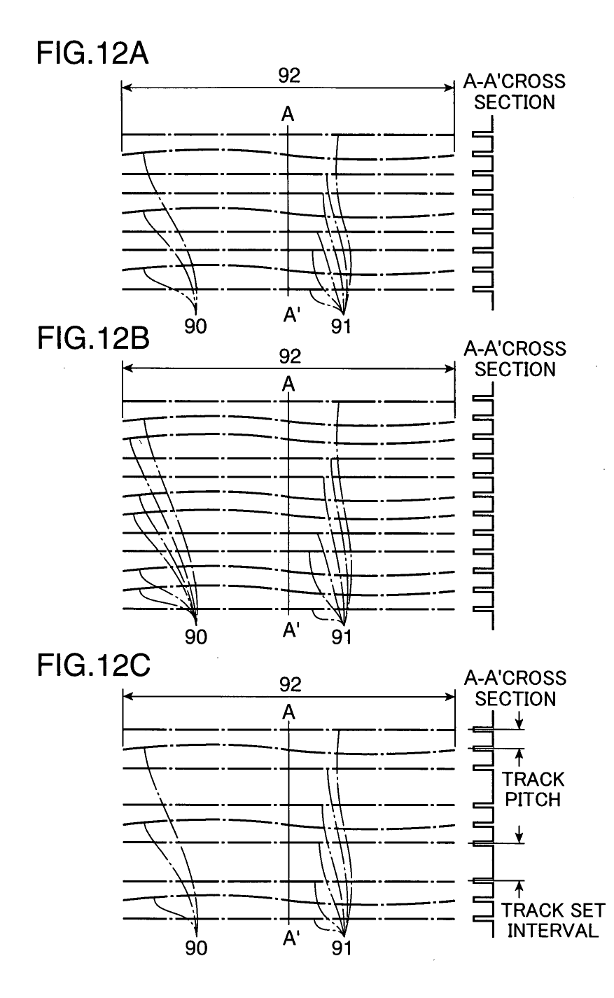

Next, an arrangement of an optical recording medium embodying the invention is described. FIG. 12A is a diagram showing a track configuration of the optical recording medium embodying the invention. The tracks of the optical recording medium include a photon mode recording layer, a phase-change write-once recording layer which is changed from a crystalline phase to an amorphous phase, or a pigment-containing write-once recording layer. The photon mode recording layer is different from a thermal recording layer in an optical magnetic disk or a phase-change rewritable disk. Specifically, in the photon mode recording layer, a variation in the optical constant of the recording material is substantially equal to a function of the intensity of a recording beam. When recording is performed with a light beam having a significantly high intensity, the recording is completed in a significantly short period. The photon mode recording layer is conceived to have a recording response time in the order of picosecond (see “Optics” Vol. 26 No. 7, 1997, 356 pp, an optical memory using a photochromic molecular material). For instance, with use of a high-output picosecond laser or a like device, it is possible to record data with one photopulse, and to record data in the order of picosecond. Similarly to the photon mode recording layer, the time required for the phase-change write-once recording layer to change from a crystalline phase to an amorphous phase is in the order of picosecond or less. Accordingly, in the following embodiment, the photon mode recording layer can be replaced by the phase-change write-once recording layer. The pigment-containing write-once recording layer has a high-speed response performance, as well as the photon mode recording layer and the phase-change write-once recording layer. Accordingly, it is possible to replace the photon mode recording layer by the pigment-containing write-once recording layer.

A recording material having a linear function or a quadratic function of the intensity of the recording beam is usable in photon mode recording. The recording, in which a variation in the optical constant of the recording material is a linear function of the intensity of the recording beam, is called as one-photon absorption recording. The recording, in which a variation in the optical constant of the recording material is a quadratic function of the intensity of the recording beam, is called as two-photon absorption recording. Examples of the recording material are fulgide compounds, diarylethene, and PAP (Photoaddressable Polymers). Both of the one-photon absorption recording and the two-photon absorption recording are enabled, using the recording materials. The recording materials are recorded by changing a refractive index, which is one of the optical constants.

As shown in FIG. 12A, which is an A-A′ cross-sectional view, a groove for tracking control is formed in the middle of each track. An odd number of adjacent tracks (in this embodiment, three tracks) are defined as a set of tracks. The groove in the middle track 90 is wobbled, and the grooves in the outermost tracks 91 each has a straight-line shape. Hereinafter, the set of tracks is also called as a track set. FIGS. 12A through 12C show that the amplitude of wobbling is about a half of the track pitch for sake of easy explanation. Actually, however, the amplitude of wobbling is one-tenth of the track pitch or smaller. The same indication is also applied hereinafter. A wobbling cycle 92 is equal to an integral multiplication of the cycle of the movement of the beam spot which is cyclically moved within the track set. Also, the cycle of the movement of the beam spot which is cyclically moved within the track set is substantially the same as one-channel bit length of the recording code in the tracking direction. Accordingly, it is conceived that the wobbling cycle 92 is an integral multiplication of the channel bit length. The same relation is also applied to the below-mentioned examples. In FIG. 12A, three track sets are shown, and the wobbling frequency and the wobbling phase are identical among the three track sets. Alternatively, the wobbling frequency and the wobbling phase may be different among the track sets.

As mentioned above, the wobbling cycle of the groove track is equal to an integral multiplication of the cycle of the movement of the light beam within one set of groove tracks. This enables to control the cycle of the movement of the light beam, using the wobbling frequency.

The wobbling cycle of the groove track is equal to an integral multiplication of one-channel bit length of the recording code to be recorded in the groove track. Accordingly, the cycle of the movement of the light beam can be controlled, using the wobbling cycle, by making the cycle of the light beam coincident with one-channel bit length.

FIG. 12B is a diagram showing a track configuration of an optical recording medium as a first modification of the embodiment. As shown in FIG. 12B, which is an A-A′ cross-sectional view, a groove for tracking control is formed in the middle of each track. An even number of tracks (in this example, four tracks) are defined as a set of tracks. The grooves in the two middle tracks 90 are wobbled, and the grooves in the outermost tracks 91 each has a straight-line shape. The wobbling frequency and the wobbling phase are identical between the two middle groove tracks. In FIG. 12B, three track sets are shown, and the wobbling frequency and the wobbling phase are identical among the three track sets. Alternatively, the wobbling frequency and the wobbling phase may be different among the track sets.

As mentioned above, the predetermined number of adjacent groove tracks are defined as the groove track set, and the middle track or the two middle tracks of the groove track set is or are wobbled at a predetermined amplitude and at a predetermined cycle. This enables to control the movement of the light beam, using the wobble signal.

The outermost groove tracks of the groove track set each has a straight-line shape, and the groove track of the groove track set other than the outermost groove tracks is wobbled. Accordingly, the groove track other than the outermost groove tracks can be used as a center of the cyclic movement of the light beam, while using the outermost groove tracks of the groove track set as a control target of the movement of the light beam.

FIG. 12C is a diagram showing a track configuration of an optical recording medium as a second modification of the embodiment. As shown in FIG. 12C, which is an A-A′ cross-sectional view, a groove for tracking control is formed in the middle of each track. An odd number of adjacent tracks (in this example three tracks) are defined as a track set. The groove in the middle track 90 is wobbled, and the grooves in the outermost tracks 91 each has a straight-line shape. The wobbling frequency and the wobbling phase of the groove tracks are identical among the track sets. Also, the interval of the adjacent track sets is set larger than the interval of the tracks within each track set. In FIG. 12C, three track sets are shown, and the wobbling frequency and the wobbling phase are identical among the three track sets. Alternatively, the wobbling frequency and the wobbling phase of the track sets may be different among the track sets.

As mentioned above, the predetermined number of adjacent groove tracks is defined as the track groove set, and the interval of the adjacent groove track sets is set larger than the interval of the groove tracks within each groove track set. This enables to prevent the light beam from erroneously shifting to the adjacent groove track set, thereby enabling to securely move the light beam within the targeted groove track set.

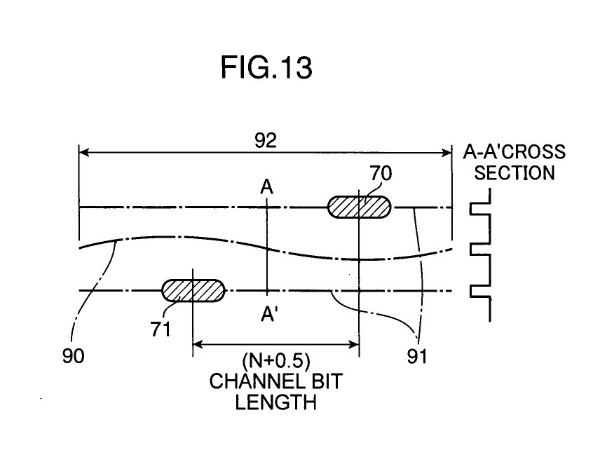

FIG. 13 is a diagram showing a track configuration of an optical recording medium as a third modification of the embodiment. As shown in FIG. 13, which is an A-A′ cross-sectional view, a groove for tracking control is formed in the middle of each track. Plural adjacent tracks (in this example, three tracks) are defined as a track set. The groove in the middle track 90 of the track set is wobbled, and the grooves in the outermost tracks 91 each has a straight-line shape. Pits 70 and 71 are pre-recorded in the outermost tracks 91 of the track set. Specifically, the pit 70 is formed in one of the outermost tracks 91, and the pit 71 is formed in the other one of the outermost tracks 91. The pits 70 and 71 may be recorded by emboss processing. The distance between the pits 70 and 71 is set to (N+0.5) times as large as the channel bit length. Simultaneously, the distance is set to (N+0.5) times as large as the cycle of the movement of the light beam which is cyclically moved within the track set. The wobbling frequency and the wobbling phase are identical among the middle groove tracks.

In this way, the reference phase pits are formed in the outermost groove tracks of the groove track set, displaced from each other by (N+0.5) cycle (N is an integer) of the cycle of the channel bit length. Accordingly, in the case where the light beam is moved with a sinusoidal waveform pattern, the phase of the light beam can be easily controlled by making the peaks and valleys of the light beam trajectory coincident with the reference phase pits.

Alternatively, the optical recording medium embodying the invention may be a multi-layered optical disk having plural recording layers and a single tracking layer, wherein the farthest layer from the disk surface where the light beam is incident serves as the tracking layer, and the tracking layer has the groove structure as shown in FIGS. 12A through 12C, and 13. The aforementioned groove track structures may be applicable to the optical recording medium provided with the plural recording layers.

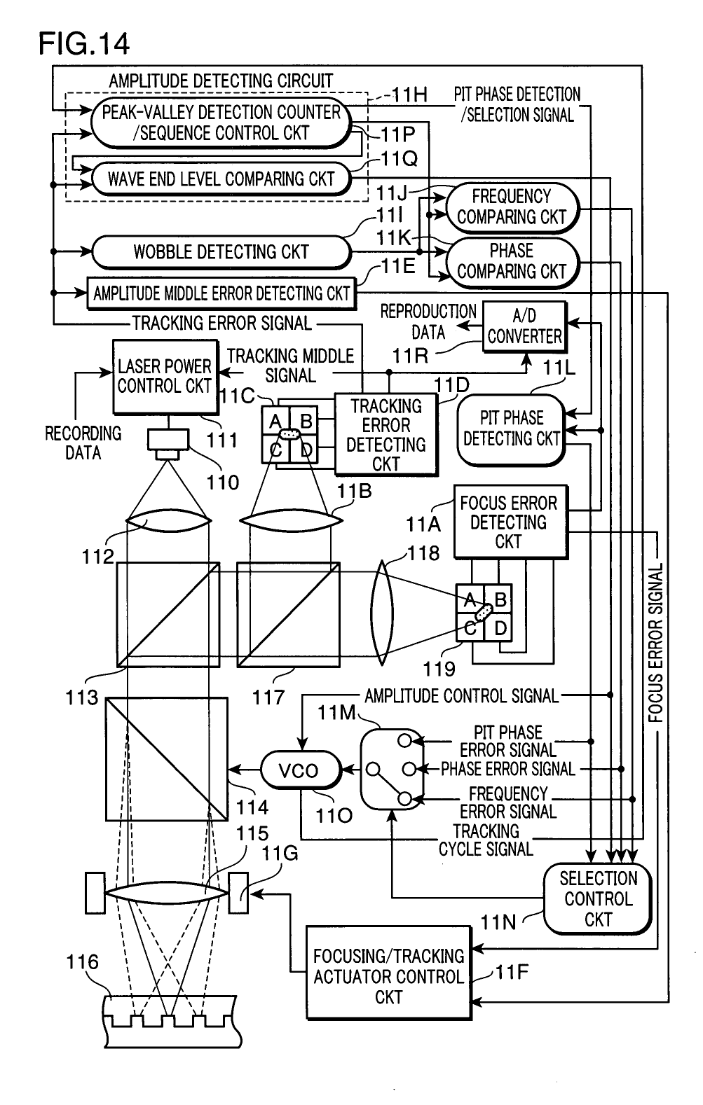

FIG. 14 is a block diagram showing an arrangement of an optical recording/reproducing apparatus embodying the invention. In FIG. 14, the blocks with round corners indicate blocks constituting a refraction control circuit.

Recording data, which has been inputted from an external device, is inputted to a laser power control circuit 111. The laser power control circuit 111 controls the optical power of a light beam emitted from a laser 110 in accordance with the inputted recording data. In recording, the laser power control circuit 11 controls the optical power of the light beam so that the light beam is impulsively irradiated with a predetermined intensity when the light beam crosses the middle of each track to designate recording of the data in one set of tracks. In reproduction, the laser power control circuit 111 designates reproduction of the data recorded in the track set by sampling a reproduction signal to be generated by receiving reflected light of the light beam when the light beam crosses the middle of the track.

Alternatively, the optical recording/reproducing apparatus of the embodiment may be provided with a laser driver for driving the laser 110. In the modification, the laser power control circuit 111 outputs, to the laser driver, a command to record the data in the track set, or a command to reproduce the data recorded in the track set. Upon receiving the command, the laser driver regulates the emission timing of the laser 110 or the power of the light beam to be outputted from the laser 110, based on the command outputted from the laser power control circuit 111.

The laser light emitted from the laser 110 is collimated into parallel light through a collimator lens 112. The parallel laser light is transmitted through a beam splitter 113, and is incident onto an EO (electro-optic) refractive device 114.

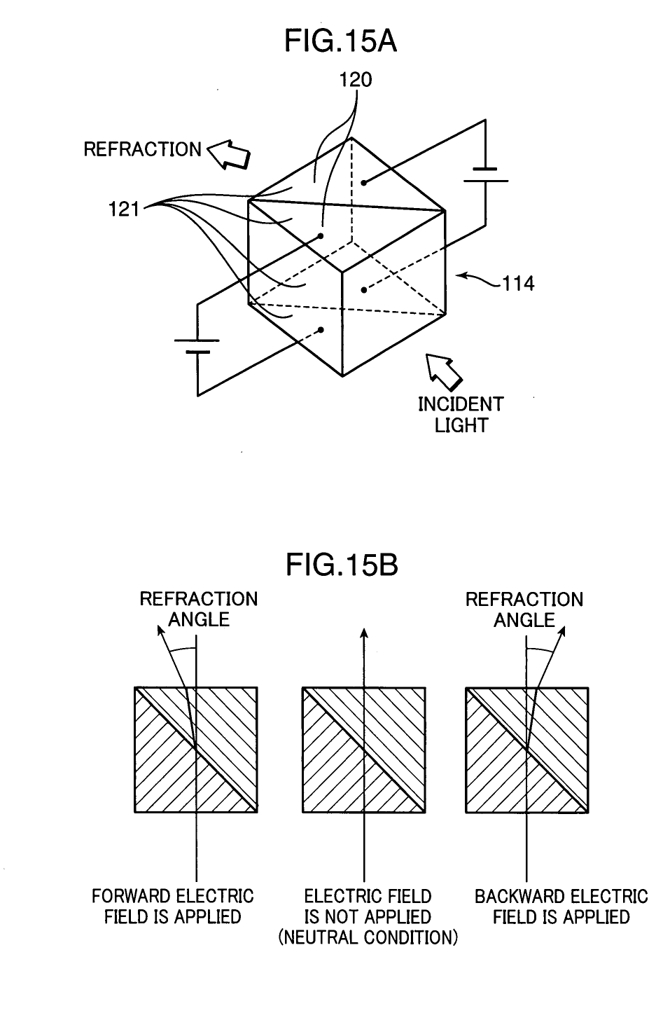

The EO refractive device 114 may be produced by applying Pockels effect, using a crystal such as LiNbO₃ crystal or KTN crystal (KTa_{1-X}Nb_{X}O₃). Pockels effect is an effect that a refractive index is changed when an electric field is applied to an oxide crystal such as KTN crystal. FIGS. 15A and 15B are diagrams for describing an operation of the EO refractive device 114 shown in FIG. 14. As shown in FIG. 15A, two triangular prisms made of an oxide crystal such as KTN crystal i.e. oxide crystal triangular prisms 120 are adhered to each other, and plane electrodes 121 are formed on upper and lower surfaces of the oxide crystal triangular prisms 120 so that an electric field is applied to the prisms. When a voltage is not applied, the incident light is propagated straight through the EO refractive device 114, and is outputted straight from the EO refractive device 114. As shown in FIG. 15A, when voltages with the same levels but with different polarities are applied to the plane electrodes 121 of the two prisms, the refractive indexes of the two prisms are changed in directions opposite to each other. As a result, the incident light is refracted on the boundary between the two prisms, and is further refracted on the outgoing surfaces of the prisms for output. As shown in FIG. 15B, when the electric field is not applied, the incident light is propagated through the EO refractive device 114 without refraction, and when the electric field is applied, the refraction angle can be controlled depending on the polarities and the magnitude of the electric field to be applied to the prisms.

The laser light whose outgoing angle is controlled by the EO refractive device 114 is condensed on a photon mode recording layer of an optical disk 116 by an objective lens 115. The optical disk 116 is e.g. an optical disk having the groove tracks as shown in FIG. 12A. The light reflected on the photon mode recording layer of the optical disk 116 is transmitted through the objective lens 115 and the EO refractive device 114, and is incident onto the beam splitter 113. The reflected light incident on the beam splitter 113 is reflected in a direction different from the incoming direction of the incident light, and is incident onto a half mirror 117. The half mirror 117 splits the incident light into two directions.

One of the split incident light is transmitted through the half mirror 117, and is incident onto a four-divided detector 119 via a cylinder lens 118. The four-divided detector 119 has four divided areas, and is adapted to convert the incident light into electric signals A, B, C, and D commensurate with the amount of light incident on the respective areas of the four-divided detector 119. A focus error signal is obtained by computing the electric signals i.e. by implementing the expression: (A+D)−(B+C). The computation is executed by a focus error detecting circuit 11A to output the computation result as a focus error signal. Thus, when the same amounts of light are incident onto the respective areas of the four-divided detector 119, it is judged that the laser beam is focused. In this embodiment, a computation (A+B+C+D) of summing the electric signals A, B, C, and D with respect to the four divided areas is executed simultaneously by the focus error detecting circuit 11A to output the computation result as a reproduction signal. Similarly to the focus error signal, the reproduction signal can be generated by a tracking error detection circuit 11D.

The other of the split incident light is reflected by the half mirror 117, and is incident onto a four-divided detector 11C via a condensing lens 11B. The four-divided detector 11C has four divided areas, and is adapted to convert the incident light into electric signals A, B, C, and D commensurate with the amount of light incident on the respective areas of the four-divided detector 11C. A tracking error signal is obtained by computing the electric signals i.e. by implementing the expression: (A+C)−(B+D). The computation is performed by a tracking error detecting circuit 11D to output the computation result as a tracking error signal. When the same amounts of light are incident onto the areas where the electric signals A and C are detected, and on the areas where the electric signals B and D are detected, and when the sum of the electric signals A and C is equal to the sum of the electric signals B and D, it is judged that the tracking control is properly executed. Simultaneously, the tracking error detecting circuit 11D outputs a pulse signal when the tracking error signal crosses the zero level. The pulse signal is defined as a tracking middle signal.

Then, the focus error signal is inputted to a focusing/tracking actuator control circuit 11F. The focusing/tracking actuator control circuit 11F controls an actuator 11G using the focus error signal for focus control.

The tracking error signal is inputted to an amplitude middle error detecting circuit 11E and to the refraction control circuit. In the optical recording/reproducing apparatus shown in FIG. 14, the blocks with round corners indicate the blocks constituting the refraction control circuit. In the recording and reproducing, the refraction control circuit is operative to designate the light beam to cyclically move with a predetermined pattern within a track set, with a predetermined number of adjacent tracks being defined as the track set.

The amplitude middle error detecting circuit 11E integrates the tracking error signal with a predetermined time constant for outputting the integration result. A signal to be outputted when the light beam is not cyclically moved within the track set, i.e. when the light beam is in the neutral position, is identical to a normal tracking error signal. The amplitude middle error detecting circuit 11E outputs a signal obtained by averaging the tracking error signal in a predetermined period. The signal outputted from the amplitude middle error detecting circuit 11E is inputted to the focusing/tracking actuator control circuit 11F. The focusing/tracking actuator control circuit 11F performs a tracking control by controlling the actuator 11G, using the signal indicating the inputted average tracking error.

The refraction control circuit includes an amplitude detecting circuit 11H, a wobble detecting circuit 11I, a frequency comparing circuit 11J, a phase comparing circuit 11K, a pit phase detecting circuit 11L, a selecting circuit 11M, a selection control circuit 11N, and a VCO (voltage control oscillator) 11O. The operations to be implemented by the refraction control circuit are divided into the following four steps.

In the first step, a tracking control with respect to the middle track of the track set is performed in a state that the light beam is kept unmoved. This is equivalent to the normal tracking control to be executed for an optical disk. In other words, the focusing/tracking actuator control circuit 11F performs the tracking control based on the signal which is outputted from the amplitude middle error detecting circuit 11E and is obtained by averaging the tracking error signal in the predetermined period.

In the second step, the amplitude control is performed in such a manner that the amplitude of the movement of the light beam within the track set is coincident with a predetermined magnitude, with the middle track of the track set being defined as a center of the light beam trajectory. At this time, the tracking error signal, and the tracking cycle signal indicating the tracking cycle are inputted to the amplitude detecting circuit 11H. The amplitude detecting circuit 11H detects the amplitude of the movement of the light beam within the track set, compares the detected amplitude with a targeted amplitude, and outputs an amplitude control signal to the VCO 11O. The VCO 11O controls the amplitude of the refraction control signal to be outputted to the EO refractive device 114 in accordance with the amplitude control signal. In recording and reproducing, the EO refractive device 114 refracts the light beam based on the refraction control signal to be inputted from the VCO 11O to cyclically move the light beam within the track set with a predetermined pattern.

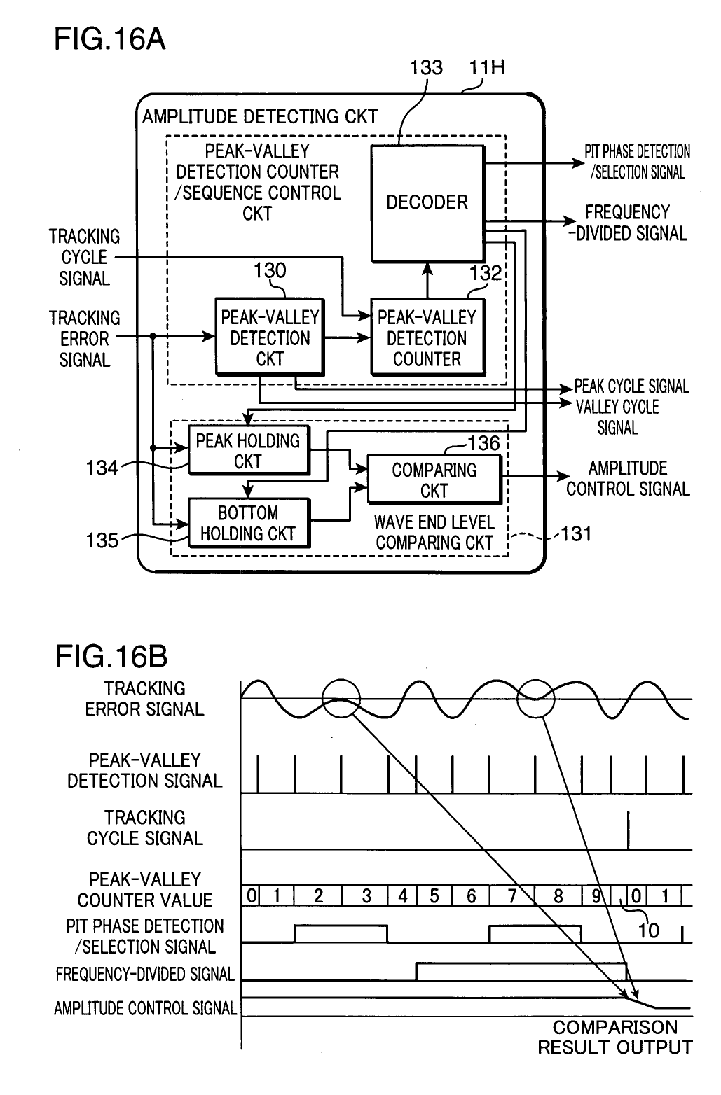

Next, a configuration of the amplitude detecting circuit 11H is described in detail. FIGS. 16A and 16B are diagrams for describing the amplitude detecting circuit shown in FIG. 14. FIG. 16A is a block diagram showing a detailed configuration of the amplitude detecting circuit, and FIG. 16B is a diagram showing a signal to be processed by the amplitude detecting circuit 11H. The amplitude detecting circuit 11H includes a peak-valley detection counter/sequence control circuit 11P, and a wave end level comparing circuit 11Q.

The peak-valley detection counter/sequence control circuit 11P has a peak-valley detection circuit 130, a peak-valley detection counter 132, and a decoder 133. The tracking error signal is inputted to the peak-valley detection circuit 130 and to the wave end level comparing circuit 131. The peak-valley detection circuit 130 is adapted to detect peaks/valleys of the tracking error signal to output a detection pulse. The detection pulse is inputted to the peak-valley detection counter 132.

The peak-valley detection counter 132 counts up each time the detection pulse is inputted. Also, the tracking cycle signal outputted from the VCO 11O is inputted to the peak-valley detection counter 132. The peak-valley detection counter 132 is reset each time the pulse of the tracking cycle signal is inputted. The peak-valley detection counter 132 counts the number of peaks/valleys in one cycle. Thus, the approximate amplitude control is performed based on the counter value counted by the peak-valley detection counter 132. The count value counted by the peak-valley detection counter 132 represents the phase of the light beam trajectory within the track set. The decoder 133 outputs a pit phase detection/selection signal or a frequency-divided signal by decoding the count output from the peak-valley detection counter 132, whereby the sequence control is performed.

The decoder 133 outputs two wave end level comparison enable signals. The decoder 133 outputs, to a peak holding circuit 134, one of the wave end level comparison enable signals at a phase corresponding to the middle of a peak of the tracking cycle, and outputs, to a bottom holding circuit 135, the other one of the wave end level comparison enable signals at a phase corresponding to the middle of a valley of the tracking cycle. The peak holding circuit 134 holds the peak voltage of the tracking error signal to be obtained when the wave end level comparison enable signal is inputted to output the peak voltage to a comparing circuit 136. Also, the bottom holding circuit 135 holds the bottom voltage of the tracking error signal to be obtained when the wave end level comparison enable signal is inputted to output the bottom voltage to the comparing circuit 136. The comparing circuit 136 outputs a difference between the peak voltage outputted from the peak holding circuit 134, and the bottom voltage outputted from the bottom holding circuit 135, as an amplitude control signal.

The amplitude control signal is outputted to the selection control circuit 11N. If the amplitude control signal is equal to or smaller than a predetermined value, the selecting circuit 11M is switched over to connect the frequency comparing circuit 11J with the VCO 11O. Then, the routine proceeds to the third step, while continuing the amplitude control.

In the third step, the tracking cycle control is performed in such a manner that the cycle of the movement of the light beam within the track set is coincident with the one-channel bit length. The wobble detecting circuit 11I generates a wobble signal by detecting wobbling of the middle track of the track set, and generates a tracking reference signal by multiplying the wobble signal. The frequency comparing circuit 11J compares the frequency of the frequency-divided signal to be outputted from the amplitude control circuit 11H, with the frequency of the tracking reference signal to be outputted from the wobble detecting circuit 11I to detect a frequency displacement, and outputs the detected displacement as a frequency error signal.

The frequency error signal is outputted to the selection control circuit 11N. If the frequency error signal is equal to or smaller than a predetermined value, the selecting, circuit 11M is switched over to connect the phase comparing circuit 11K with the VCO 11O. Then, the routine proceeds to the fourth step.

In the fourth step, the tracking phase control is performed in such a manner that the phase of the movement of the light beam within the track set is coincident with a predetermined phase corresponding to a predetermined position on the track. First, the phase of tracking is made coincident with the phase of wobbling. The phase comparing circuit 11K compares the phase of the frequency-divided signal to be outputted from the amplitude control circuit 11H with the phase of the tracking reference signal to be outputted from the wobble detecting circuit 11I to detect a frequency displacement, and outputs the detected displacement as a phase error signal.

The phase error signal is outputted to the selection control circuit 11N. If the phase error signal is equal to or smaller than a predetermined value, the selecting circuit 11M is switched over to connect the pit phase detecting circuit 11L with the VCO 11O. Then, the routine proceeds to a pit phase synchronization mode.

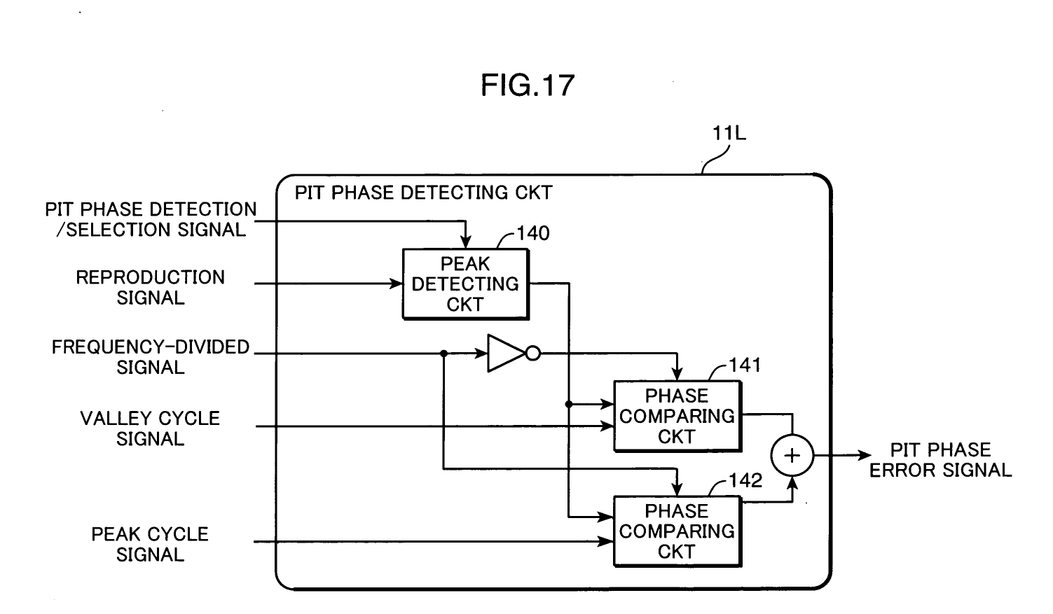

When the optical recording/reproducing apparatus is in the pit phase synchronization mode, the phase of tracking is made equal to or smaller than the pit length by detecting the pit which has been recorded in the optical disk, and by precisely matching the phase corresponding to detection of the pit with the phase of tracking. FIG. 17 is a block diagram showing a configuration of the pit phase detecting circuit 11L shown in FIG. 14. The pit phase detecting circuit 11L is adapted to receive a pit phase detection/selection signal, a reproduction signal, a valley cycle signal, a peak cycle signal, and a frequency-divided signal for separating a valley from a peak, and to output a pit phase error signal. The pit phase detection/selection signal represents an approximate timing at which the reference pits recorded in the outermost tracks of the track set are detected.

The peak detecting circuit 140 detects a peak of the reproduction signal in a period when the pit phase detection/selection signal is asserted to output a pit phase pulse. The pit phase pulse is inputted to a phase comparing circuit 141 and to a phase comparing circuit 142. The phase comparing circuit 141 compares the pit phase pulse to be inputted to a valley of the frequency-divided signal, with the phase of the valley cycle signal to output the comparison result as an error signal. The phase comparing circuit 142 compares the pit phase pulse to be inputted to a peak of the frequency-divided signal, with the phase of the peak cycle signal to output the comparison result as an error signal. The result of summation of the two error signals is outputted as a pit phase error signal.

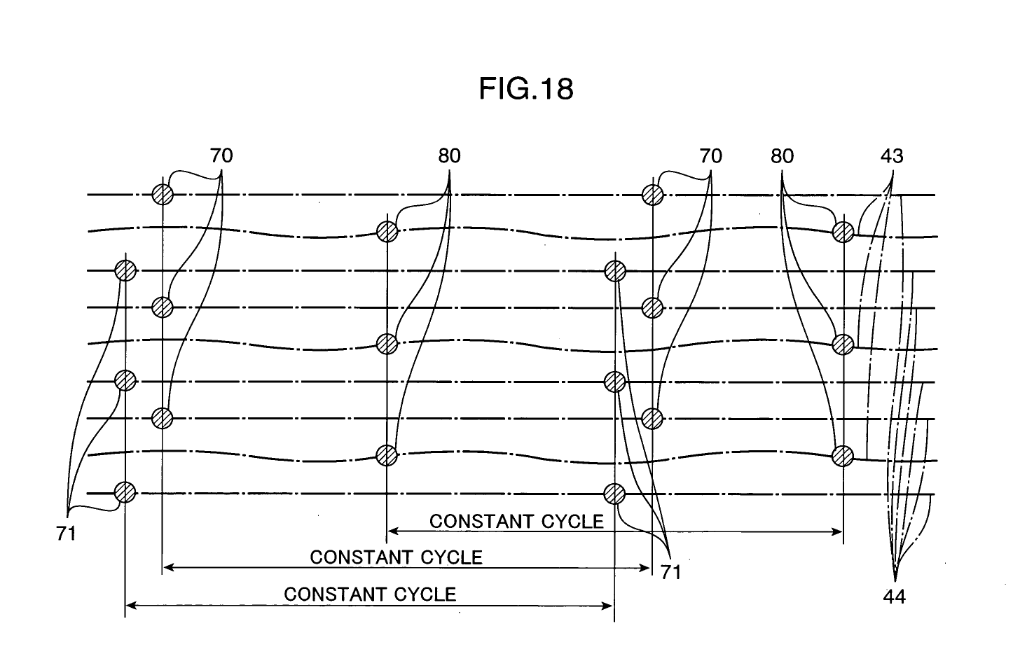

FIG. 18 is a diagram showing a disposition of reference pits to be formed in the optical recording medium. The outer reference pits 70, the outer reference pits 71, and the middle reference pits 80 are recorded with a predetermined cycle for easy detection. Alternatively, the reference pits may be formed in combination with physical addresses.

In the above arrangement, if the pit phase error is equal to or smaller than a predetermined value, recording data is inputted to the laser power control circuit 111. Then, in response to assertion of the tracking middle signal, the laser power control circuit 111 is operated to record the data in the predetermined track while impulsively increasing the laser power.

In reproduction, the laser power control circuit 111 controls the power of the laser 110 to a constant reproduction power. Then, reproduction data can be obtained by sampling the reproduction signal (signal obtained by summing the four signals outputted from the four detecting portions of the four-divided detector 119) to be outputted from the focus error detecting circuit 11A, using an A/D (analog-to-digital) converter 11R, at a timing when the tracking middle signal of the predetermined track is asserted.

In the embodiment, the optical recording/reproducing apparatus corresponds to an example of an optical recording control circuit, an optical recording apparatus, an optical reproduction control circuit, an optical reproduction apparatus, and a tracking control circuit of the claimed invention. The refraction control circuit corresponds to an example of a movement designator of the claimed invention. The laser power control circuit 111 corresponds to an example of a recording designator and a reproduction designator of the claimed invention. The EO refractive device corresponds to an example of a mover of the claimed invention. The laser power control circuit 111 and the laser 110 correspond to an example of a recorder of the claimed invention. The laser power control circuit 111, the laser 110, the focus error detecting circuit 11A, and the A/D converter 11R correspond to an example of a reproducer of the claimed invention.

Also, the amplitude middle error detecting circuit 11E and the focusing/tracking actuator control circuit 11F correspond to an example of a tracking controller of the claimed invention. The amplitude detecting circuit 11H and the VCO 11O correspond to an example of an amplitude controller of the claimed invention. The wobble detecting circuit 11I, the amplitude detecting circuit 11H, the frequency comparing circuit 11J, and the VCO 11O correspond to an example of a cycle controller of the claimed invention. The amplitude detecting circuit 11H, the pit phase detecting circuit 11L, and the VCO 11O correspond to an example of a phase controller of the claimed invention.

As mentioned above, in recording, the laser power control circuit 111 impulsively controls the optical power of the laser light to be outputted from the laser 110 in response to receiving the recording data and the tracking middle signal. The collimator lens 112 collimates the laser light outputted from the laser 110 in parallel light. The EO refractive device 114 refracts the parallel light collimated by the collimator lens 112 in the radial direction of the optical disk 116, based on the refractive index control signal for cyclically moving the laser light with the predetermined pattern in the predetermined number of adjacent tracks. The objective lens 115 condenses the parallel light refracted by the EO refractive device 114, and forms a focus spot on the track in the recording layer of the optical disk 116. The tracking error detecting circuit 11D receives the reflected light from the focus spot to output a tracking error signal and a tracking middle signal indicating the middle of the track. The refraction control circuit receives the tracking error signal, and outputs, to the EO refractive device 114, the refractive index control signal to be used in cyclically moving the light beam with the predetermined pattern within the predetermined number of adjacent tracks. The amplitude middle error detecting circuit 11E receives the tracking error signal, and outputs, to the actuator 11G, the amplitude middle error signal obtained by averaging the tracking error signal which has been inputted in the predetermined period. The actuator 11G drives the objective lens 115 based on the amplitude middle error signal.

In this way, the time required for recording the data can be shortened by recording the data while controlling the power of the laser light so that the light beam is irradiated impulsively when the light beam crosses the middle of each track of the track set constituted of the predetermined number of adjacent tracks, thereby enabling to increase the data transfer rate.

Also, in reproduction, the laser power control circuit 111 controls the optical power of the laser 110 to the predetermined value. The collimator lens 112 collimates the laser light outputted from the laser 110 into parallel light. The EO refractive device 114 cyclically moves the laser light with the predetermined pattern within the predetermined number of adjacent tracks, and refracts the parallel light collimated by the collimator lens 112 in the radial direction of the optical disk 116, based on the refractive index control signal to be used in matching the tracking cycle of the laser light with the cycle of one-channel bit length of the recording code to be recorded in the tracking direction. The objective lens 115 condenses the parallel light refracted by the EO refractive device 114, and forms a focus spot on the track in the recording layer of the optical disk 116. The tracking error detecting circuit 11D receives the reflected light from the focus spot, and outputs the tracking error signal, the tracking middle signal indicating the middle of the track, and the reproduction signal. The refraction control circuit receives the tracking error signal, and outputs the refractive index control signal to the EO refractive device 114. The amplitude middle error detecting circuit 11E receives the tracking error signal, and outputs, to the actuator 11G, the amplitude middle error signal obtained by averaging the tracking error signal which has been inputted in the predetermined period. The actuator 11G drives the objective lens 115 based on the amplitude middle error signal. The A/D converter 11R receives the tracking middle signal and the reproduction signal, and outputs the reproduction data by sampling the reproduction signal when the tracking middle signal is asserted.

Thus, data recorded with a high-density can be reproduced by reproducing the data while controlling the optical power of the laser light to be outputted from the laser 110 when the laser light is cyclically moved within the one-channel bit and crosses the middle of the track.

The aforementioned embodiments may primarily embrace the inventions having the following arrangements.

An optical recording control method according to an aspect of the invention comprises a movement designation step of designating a light beam to cyclically move in a track set with a predetermined pattern, the track set being constituted of adjacent tracks of a predetermined number; and a recording designation step of designating recording of data in the track set by controlling a power of the light beam so that the light beam is impulsively irradiated with a predetermined intensity when the light beam crosses a middle of each of the tracks.

An optical recording control circuit according to another aspect of the invention comprises: a movement designator for designating a light beam to cyclically move in a track set with a predetermined pattern, the track set being constituted of adjacent tracks of a predetermined number; and a recording designator for designating recording of data in the track set by controlling a power of the light beam so that the light beam is impulsively irradiated with a predetermined intensity when the light beam crosses a middle of each of the tracks.

An optical recording method according to another aspect of the invention comprises: a moving step of cyclically moving a light beam in a track set with a predetermined pattern, the track set being constituted of adjacent tracks of a predetermined number; and a recording step of recording data in the track set by controlling a power of the light beam so that the light beam is impulsively irradiated with a predetermined intensity when the light beam crosses a middle of each of the tracks.

An optical recording apparatus according to another aspect of the invention comprises: a mover for cyclically moving a light beam in a track set with a predetermined pattern, the track set being constituted of adjacent tracks of a predetermined number; and a recorder for recording data in the track set by controlling a power of the light beam so that the light beam is impulsively irradiated with a predetermined intensity when the light beam crosses a middle of each of the tracks.

In the above arrangements, the light beam is cyclically moved in the track set with the predetermined pattern, with the track set being constituted of the adjacent tracks of the predetermined number. The data is recorded in the track set by controlling the power of the light beam so that the light beam is impulsively irradiated with the predetermined intensity when the light beam crosses the middle of the each of the tracks.

Thus, the data is recorded by controlling the power of the light beam so that the light beam is impulsively irradiated when the light beam crosses the middle of the each of the adjacent tracks of the predetermined number. This enables to shorten the time required for data recording, thereby enabling to increase a data transfer rate.

In the optical recording control method, preferably, the cycle of the movement of the light beam in the track set is coincident with a cycle of one-channel bit length of a recording code to be recorded in a tracking direction.

In the above arrangement, the cycle of the movement of the light beam in the track set is coincident with the cycle of the one-channel bit length of the recording code to be recorded in the tracking direction. Accordingly, the data can be recorded with a high density by recording the data while controlling the power of the light beam so that the light beam is impulsively irradiated when the light beam is cyclically moved within the one-channel bit, and the light beam crosses the middle of the track.

In the optical recording control method, preferably, the track set is constituted of the tracks of an odd number. In this arrangement, the track set is constituted of the tracks of the odd number. Accordingly, in the case where the light beam is moved in the tracks of the odd number, the middle track is coincident with the center of the movement of the light beam. This enables to easily detect and correct displacement of the movement of the light beam, thereby enabling to realize data recording with less jitter.

In the optical recording control method, preferably, a trajectory of the light beam to be moved in the track set has a triangular waveform. In this arrangement, since the trajectory of the light beam to be moved in the track set has the triangular waveform, the light beam can be moved across the tracks.

In the optical recording control method, preferably, a trajectory of the light beam to be moved in the track set has a sinusoidal waveform. In this arrangement, since the trajectory of the light beam to be moved in the track set has the sinusoidal waveform, the light beam can be easily moved by controlling the amplitude, the frequency, and the phase of the trajectory of the light beam.

In the optical recording control method, preferably, the recording designation step includes: designating recording of the data in the track other than outermost tracks of the track set by controlling the power of the light beam so that the light beam is impulsively irradiated with the predetermined intensity when the light beam crosses the middle of the track other than the outermost tracks of the track set.

In the above arrangement, the data is recorded in the track other than the outermost tracks of the track set by controlling the optical power of the light beam so that the light beam is impulsively irradiated with the predetermined intensity when the light beam crosses the middle of the track other than the outermost tracks of the track set. This enables to record the data in a linear portion of the movement of the light beam i.e. in a portion where the trajectory of the light beam is most stabilized, thereby enabling to reduce jitter in recording.

In the optical recording control method, preferably, the recording designation step includes designating recording of the data in the track set or in the track other than outermost tracks of the track set by controlling the power of the light beam so that the light beam is impulsively irradiated with the predetermined intensity when the cycle of the movement of the light beam in the track set is in a range from a 90-degree phase to a 270-degree phase, the optical recording control method further comprising: a reproduction designation step of: designating reproduction of data recorded in the track set or in the track other than the outermost tracks of the track set by controlling the optical power of the light beam to a reproduction power when the cycle of the movement of the light beam in the track set is in a range from the 270-degree phase to the 90-degree phase, and by sampling a reproduction signal to be generated in receiving reflected light of the light beam when the light beam crosses the track set or the middle of the track other than the outermost tracks of the track set.

In the above arrangement, the data recorded in the track set or in the track other than the outermost tracks of the track set by controlling the power of the light beam so that the light beam is impulsively irradiated with the predetermined intensity when the cycle of the movement of the light beam in the track set is in the range from the 90-degree phase to the 270-degree phase. Then, the data recorded in the track set or in the track other than the outermost tracks of the track set is reproduced by controlling the power of the light beam to the reproduction power when the cycle of the movement of the light beam in the track set is in the range from the 270-degree phase to the 90-degree phase, and by sampling the reproduction signal to be generated in receiving the reflected light of the light beam when the light beam crosses the track set or the middle of the track other than the outermost tracks of the track set.

The data recorded in the range from the 90-degree phase to the 270-degree phase can be verified to have a predetermined configuration by performing a proper signal processing such as partial response equalization, based on the reproduction signal to be generated when the cycle of the movement of the light beam in the track set is in the range from the 270-degree phase to the 90-degree phase of the cycle of the movement of the light beam. Thus, by recording and reproducing data within one cycle, the recorded data (marks and spaces) can be verified on a real-time basis, which enables to enhance recording reliability.

An optical reproduction control method according to another aspect of the invention comprises: a movement designation step of designating a light beam to cyclically move in a track set with a predetermined pattern, the track set being constituted of adjacent tracks of a predetermined number; and a reproduction designation step of designating reproduction of data recorded in the track set by sampling a reproduction signal to be generated in receiving reflected light of the light beam when the light beam crosses a middle of the track, wherein the cycle of the movement of the light beam in the track set is coincident with a cycle of one-channel bit length of a recording code to be recorded in a tracking direction.

An optical reproduction control circuit according to another aspect of the invention comprises: a movement designator for designating a light beam to cyclically move in a track set with a predetermined pattern, the track set being constituted of adjacent tracks of a predetermined number; and a reproduction designator for designating reproduction of data recorded in the track set by sampling a reproduction signal to be generated in receiving reflected light of the light beam when the light beam crosses a middle of the track, wherein the cycle of the movement of the light beam in the track set is coincident with a cycle of one-channel bit length of a recording code to be recorded in a tracking direction.

An optical reproduction method according to another aspect of the invention comprises: a moving step of cyclically moving a light beam in a track set with a predetermined pattern, the track set being constituted of adjacent tracks of a predetermined number; and a reproduction step of reproducing data recorded in the track set by sampling a reproduction signal to be generated in receiving reflected light of the light beam when the light beam crosses a middle of the track, wherein the cycle of the movement of the light beam in the track set is coincident with a cycle of one-channel bit length of a recording code to be recorded in a tracking direction.

An optical reproduction apparatus according to another aspect of the invention comprises: a mover for cyclically moving a light beam in a track set with a predetermined pattern, the track set being constituted of adjacent tracks of a predetermined number; and a reproducer for reproducing data recorded in the track set by sampling a reproduction signal to be generated in receiving reflected light of the light beam when the light beam crosses a middle of the track, wherein the cycle of the movement of the light beam in the track set is coincident with a cycle of one-channel bit length of a recording code to be recorded in a tracking direction.

In the above arrangements, the light beam is cyclically moved in the track set with the predetermined pattern, with the track set being constituted of the adjacent tracks of the predetermined number. The data recorded in the track set is reproduced by sampling the reproduction signal to be generated in receiving the reflected light of the light beam when the light beam crosses the middle of the track. The cycle of the movement of the light beam in the track set is coincident with the cycle of one-channel bit length of the recording code to be recorded in the tracking direction.

Thus, the data recorded with a high density can be reproduced by reproducing the data while controlling the reproduction power of the light beam when the light beam is cyclically moved in one-channel bit, and the light beam crosses the middle of the track.

In the optical reproduction control method, preferably, the track set is constituted of the tracks of an odd number. In this arrangement, the track set is constituted of the tracks of the odd number. Accordingly, in the case where the light beam is moved in the tracks of the odd number, the middle track is coincident with the center of the movement of the light beam. This enables to easily detect and correct displacement of the movement of the light beam, thereby enabling to realize data reproduction with less jitter.

In the optical reproduction control method, preferably, a trajectory of the light beam to be moved in the track set has a triangular waveform. In this arrangement, since the trajectory of the light beam to be moved in the track set has the triangular waveform, the light beam can be moved across the tracks.

In the optical reproduction control method, a trajectory of the light beam to be moved in the track set has a sinusoidal waveform. In this arrangement, since the trajectory of the light beam to be moved in the track set has the sinusoidal waveform, the light beam can be easily moved by controlling the amplitude, the frequency, and the phase of the trajectory of the light beam.

In the optical reproduction control method, preferably, the reproduction designation step includes: designating reproduction of the data recorded in the track other than outermost tracks of the track set by sampling a reproduction signal to be generated in receiving reflected light of the light beam when the light beam crosses the middle of the track other than the outermost tracks of the track set.

In the above arrangement, the data recorded in the track other than the outermost tracks of the track set is reproduced by sampling the reproduction signal to be generated in receiving the reflected light of the light beam when the light beam crosses the middle of the track other than the outermost tracks of the track set. This enables to reproduce the data in a linear portion of the movement of the light beam i.e. in a portion where the trajectory of the light beam is most stabilized, thereby enabling to reduce jitter in reproduction.

In the optical reproduction control method, preferably, the reproduction designation step includes: designating reproduction of the data recorded in the track set or in the track other than outermost tracks of the track set by controlling a power of the light beam to a reproduction power when the cycle of the movement of the light beam in the track set is in a range from a 90-degree phase to a 270-degree phase, and by sampling a reproduction signal to be generated in receiving reflected light of the light beam when the light beam crosses the track set or the middle of the track other than the outermost tracks of the track set; and designating reproduction of the data recorded in the track set or in the track other than the outermost tracks of the track set by controlling the power of the light beam to the reproduction power when the cycle of the movement of the light beam in the track set is in a range from the 270-degree phase to the 90-degree phase, and by sampling the reproduction signal when the light beam crosses the track set or the middle of the track other than the outermost tracks of the track set.

In the above arrangement, the data recorded in the track set or in the track other than the outermost tracks of the track set is reproduced by controlling the optical power of the light beam to the reproduction power when the cycle of the movement of the light beam in the track set is in the range from the 90-degree phase to the 270-degree phase, and by sampling the reproduction signal to be generated in receiving the reflected light of the light beam when the light beam crosses the track set or the middle of the track other than the outermost tracks of the track set. Then, the data recorded in the track set or in the track other than the outermost tracks of the track set is reproduced by controlling the power of the light beam to the reproduction power when the cycle of the movement of the light beam in the track set is in the range from the 270-degree phase to the 90-degree phase, and by sampling the reproduction signal when the light beam crosses the track set or the middle of the track other than the outermost tracks of the track set.

Thus, the data is reproduced by the movement of the light beam in one cycle i.e. by sampling the reproduction signal concerning the tracks twice in one-channel bit length of a recording code. This enables to verify the reproduction data on a real-time basis, which enables to enhance reproduction reliability.

An optical recording medium according to another aspect of the invention comprises: a plurality of tracks; and a recording layer, wherein the adjacent tracks of a predetermined number constitute a track set, and the middle track or the two middle tracks of the track set is or are wobbled at a predetermined amplitude and at a predetermined cycle.

In the above arrangement, the adjacent tracks of the predetermined number constitute the track set, and the middle track or the two middle tracks of the track set is or are wobbled at the predetermined amplitude and at the predetermined cycle. This enables to control the movement of the light beam, using a wobble signal.

An optical recording medium according to another aspect of the invention comprises: a plurality of tracks; and a recording layer, wherein the adjacent tracks of a predetermined number constitute a track set, and an interval between the track sets adjacent to each other is set wider than an interval between the tracks of each of the track sets.

In the above arrangement, the adjacent tracks of the predetermined number constitute the track set, and the interval between the track sets adjacent to each other is set wider than the interval between the tracks of each of the track sets. This enables to prevent the light beam from being erroneously moved to the adjacent track set, thereby enabling to securely move the light beam within one track set.

In the optical recording medium, preferably, each of outermost tracks of the track set has a straight-line shape, and the track other than the outermost tracks of the track set is wobbled. In this arrangement, the outermost tracks of the track set each has a straight-line shape, and the track other than the outermost tracks of the track set is wobbled. This enables to use the outermost tracks of the track set as a control target for the light beam, and enables to use the track other than the outermost tracks as a center of the cyclic movement of the light beam.

In the optical recording medium, preferably, the track has a wobbling cycle equal to an integral multiplication of a cycle of a movement of a light beam in the track set. In this arrangement, since the wobbling cycle of the track is equal to the integral multiplication of the cycle of the movement of the light beam in the track set, the cycle of the movement of the light beam can be controlled, using the wobbling cycle.

In the optical recording medium, preferably, the wobbling cycle of the track is set to an integral multiplication of one-channel bit length of a recording code to be recorded in the track. In this arrangement, since he wobbling cycle of the track is set to the integral multiplication of one-channel bit length of the recording code to be recorded in the track, the cycle of the movement of the light beam can be controlled, using the wobbling cycle, by setting the cycle of the light beam to the one-channel bit length.

In the optical recording medium, preferably, reference phase pits are formed in outermost tracks of the track set, displaced from each other by (N+0.5) cycle with respect to a cycle of the one-channel bit length, where N is an integer. In this arrangement, the reference phase pits are formed, in the outermost tracks of the track set, displaced from each other by (N+0.5) cycle with respect to the cycle of the one-channel bit length, where N is an integer. Accordingly, in the case where the light beam is moved sinusoidally, the phase of the light beam can be easily controlled by making the peak and valley of the trajectory of the light beam coincident with the reference phase pits.

An optical recording medium according to another aspect of the invention comprises: a track; and a plurality of recording layers, wherein the track is formed in a farthest layer, of the recording layers, from an incident surface of a light beam, the farthest layer having a structure identical to a structure of any one of the aforementioned optical recording media. With this arrangement, the structure of the aforementioned track can be applied to the optical recording medium provided with the plural recording layers.

A tracking control method according to another aspect of the invention comprises: a first step of performing a tracking control with respect to a middle track of a track set, the track set being constituted of adjacent tracks of a predetermined number; a second step of controlling a light beam to be cyclically moved with a predetermined magnitude of amplitude, with a middle of the middle track of the track set being defined as a center of a trajectory of the light beam; a third step of controlling the light beam to be cyclically moved in the track set with a predetermined cycle; and a fourth step of controlling the light beam to be cyclically moved in the track set with a predetermined phase corresponding to a predetermined position of the track set.

A tracking control circuit according to another aspect of the invention comprises: a tracking controller for performing a tracking control with respect to a middle track of a track set, the track set being constituted of adjacent tracks of a predetermined number; an amplitude controller for controlling a light beam to be cyclically moved with a predetermined magnitude of amplitude, with a middle of the middle track of the track set being defined as a center of a trajectory of the light beam; a cycle controller for controlling the light beam to be cyclically moved in the track set with a predetermined cycle; and a phase controller for controlling the light beam to be cyclically moved in the track set with a predetermined phase corresponding to a predetermined position of the track set.

In the above arrangements, tracking control with respect to the middle track of the track set is performed, with the track set being constituted of the adjacent tracks of the predetermined number, and the light beam to be cyclically moved is controlled to be moved with the predetermined magnitude of amplitude, with the middle of the middle track of the track set being defined as the center of the trajectory of the light beam. Then, the light beam to be cyclically moved in the track set is controlled to be moved with the predetermined cycle, and the light beam to be cyclically moved in the track set is controlled to be moved with the predetermined phase corresponding to the predetermined position of the track set.

Thus, the tracking control of the light beam is performed with respect to the middle track of the track set, and then, the amplitude of the light beam is controlled. Then, the cycle of the movement of the light beam is controlled, and subsequently, the phase of the light beam is controlled. This enables to sinusoidally move the light beam.

In the tracking control method, preferably, in the second step, a center position control with respect to the movement of the light beam is performed by detecting a tracking error signal at a 0-degree phase and a 180-degree phase of the cycle of the movement of the light beam in the track set, as a displacement between the middle of the middle track of the track set, and a center of the cyclic movement of the light beam.

In the above arrangement, the center position control with respect to the movement of the light beam is performed by detecting the tracking error signal at the 0-degree phase and the 180-degree phase of the cycle of the movement of the light beam in the track set, as the displacement between the middle of the middle track of the track set, and the center of the cyclic movement of the light beam.

Thus, by detecting the tracking error signal at the 0-degree phase and the 180-degree phase of the cycle of the movement of the light beam, i.e. when the light beam passes the middle track, the displacement between the middle of the middle track of the track set, and the center of the cyclic movement of the light beam can be detected. This enables to perform the center position control with respect to the movement of the light beam based on the tracking error signal.

In the tracking control method, preferably, in the second step, a center position control with respect to the movement of the light beam is performed by detecting a tracking error signal integrated with a predetermined time constant, as a displacement between the middle of the middle track of the track set, and a center of the cyclic movement of the light beam.

In the above arrangement, the center position control with respect to the movement of the light beam is performed by detecting the tracking error signal integrated with a predetermined time constant, as the displacement between the middle of the middle track of the track set, and the center of the cyclic movement of the light beam. Thus, by integrating the tracking error signal with the appropriate time constant, the average position of the movement of the light beam i.e. the displacement of the center position of the trajectory of the cyclic movement of the light beam in the track set with respect to the middle of the middle track of the track set can be detected. This enables to control the movement of the light beam in such a manner that the center position of the trajectory of the cyclic movement of the light beam in the track set is coincident with the middle of the middle track of the track set.

In the tracking control method, preferably, in the second step, the amplitude of the movement of the light beam is controlled by setting the number of peaks of a tracking error signal in one cycle of the movement of the light beam to a predetermined value.

In the above arrangement, the amplitude of the movement of the light beam is controlled by setting the number of peaks of the tracking error signal in the one cycle of the movement of the light beam to the predetermined value. Specifically, as far as the amplitude lies within a predetermined amplitude range, with a targeted amplitude being defined in the center of the amplitude range, the number of peaks of the tracking error signal is constant. Accordingly, approximate amplitude control can be performed by increasing the amplitude if the number of peaks is smaller than a predetermined number, and by decreasing the amplitude if the number of peaks is larger than the predetermined number.

In the tracking control method, preferably, in the second step, the amplitude of the movement of the light beam is controlled with a difference signal of a tracking error signal at two maximal amplitudes of the movement of the light beam, the tracking error signal being detected in one cycle of the movement of the light beam.

In the above arrangement, the amplitude of the movement of the light beam is controlled based on the difference signal of the tracking error signal at the two maximal amplitudes of the movement of the light beam, the tracking error signal being detected in the one cycle of the movement of the light beam. Thus, the amplitude control is performed at the largest amplitude i.e. in such a manner that the tracking error signals at the 90-degree phase and the 270-degree phase are coincident with each other in the one cycle of the movement of the light beam in the track set. This enables to control the movement of the light beam in such a manner that the light beam crosses the middle of the outermost tracks of the track set.

In the tracking control method, preferably, in the third step, a cycle control with respect to the movement of the light beam is performed: by generating a wobble detecting signal concerning the track set by detecting the tracking error signal at a predetermined phase in the cyclic movement of the light beam in the track set; by generating a tracking reference signal having a frequency equal to a predetermined integral multiplication of a frequency of the wobble detecting signal; by generating a frequency-divided signal by frequency-dividing a peak-valley detection signal indicating detection of a peak or a valley of the tracking error signal by a predetermined number; and based on a comparison result between the frequency of the tracking reference signal with a frequency of the frequency-divided signal.

In the above arrangement, the wobble detecting signal concerning the track set is generated by detecting the tracking error signal at the predetermined phase in the cyclic movement of the light beam in the track set. Then, the tracking reference signal having the frequency equal to the predetermined integral multiplication of the frequency of the wobble detecting signal is generated. Then, the frequency-divided signal is generated by frequency-dividing the peak-valley detection signal indicating detection of the peak or the valley of the tracking error signal by the predetermined number, and the cycle control with respect to the movement of the light beam is performed based on the comparison result between the frequency of the tracking reference signal with the frequency of the frequency-divided signal. Thus, the cycle of the movement of the light beam in the track set can be properly controlled by comparing the frequency of the tracking reference signal with the frequency of the frequency-divided signal.

In the tracking control method, preferably, in the third step, a cycle control with respect to the movement of the light beam is performed: by generating a wobble detecting signal concerning the track set by integrating the tracking error signal to be obtained when the light beam is cyclically moved in the track set with a predetermined time constant; by generating a tracking reference signal having a frequency equal to a predetermined integral multiplication of a frequency of the wobble detecting signal; by generating a frequency-divided signal by frequency-dividing a peak-valley detection signal indicating detection of a peak or a valley of the tracking error signal by a predetermined number; and based on a comparison result between the frequency of the tracking reference signal with a frequency of the frequency-divided signal.

In the above arrangement, the wobble detecting signal concerning the track set is generated by integrating the tracking error signal to be obtained when the light beam is cyclically moved in the track set with the predetermined time constant. Then, the tracking reference signal having the frequency equal to the predetermined integral multiplication of the frequency of the wobble detecting signal is generated. Then, the frequency-divided signal is generated by frequency-dividing the peak-valley detection signal indicating detection of the peak or the valley of the tracking error signal by the predetermined number, and the cycle control with respect to the movement of the light beam is performed based on the comparison result between the frequency of the tracking reference signal with the frequency of the frequency-divided signal.

Thus, a tracking reference signal equivalent to the tracking reference signal obtained by sampling the tracking error signal at the predetermined phase can be generated by integrating with the proper time constant, without sampling the tracking error signal at the predetermined phase.

In the tracking control method, preferably, the tracking reference signal has a cycle coincident with an integral multiplication of a cycle of one-channel bit length of a recording code to be recorded in a tracking direction. In this arrangement, the cycle of the tracking reference signal is coincident with the integral multiplication of the cycle of one-channel bit length of the recording code to be recorded in the tracking direction. Thus, the cycle of the movement of the light beam in the track set can be controlled to be coincident with the cycle of one-channel bit length of the recording code to be recorded in the tracking direction of the tracks by comparing the frequency of the tracking reference signal with the frequency of the frequency-divided signal.

In the tracking control method, preferably, in the fourth step, a phase control with respect to the movement of the light beam is performed: by generating the wobble detecting signal concerning the track set by detecting the tracking error signal at the predetermined phase in the cycle of the movement of the light beam in the track set; by generating the tracking reference signal having the frequency equal to the predetermined integral multiplication of the frequency of the wobble detecting signal; by generating the frequency-divided signal by frequency-dividing the peak-valley detection signal indicating detection of the peak or the valley of the tracking error signal by the predetermined number; and based on a comparison result between a phase of the tracking reference signal with a phase of the frequency-divided signal.

In the above arrangement, the wobble detecting signal concerning the track set is generated by detecting the tracking error signal at the predetermined phase in the one cycle of the movement of the light beam in the track set. Then, the tracking reference signal having the frequency equal to the predetermined integral multiplication of the frequency of the wobble detecting signal is generated. Then, the frequency-divided signal is generated by frequency-dividing the peak-valley detection signal indicating detection of the peak or the valley of the tracking error signal by the predetermined number, and the phase control with respect to the movement of the light beam is performed based on the comparison result between the phase of the tracking reference signal with the phase of the frequency-divided signal. This enables to properly control the phase of the movement of the light beam in the track set by comparing the phase of the tracking reference signal with the phase of the frequency-divided signal.

In the tracking control method, preferably, in the fourth step, a phase control concerning the movement of the light beam is performed: by generating the wobble detecting signal concerning the track set by integrating the tracking error signal to be obtained when the light beam is cyclically moved in the track set with the predetermined time constant; by generating the tracking reference signal having the frequency equal to the predetermined integral multiplication of the frequency of the wobble detecting signal; by generating the frequency-divided signal by frequency-dividing the peak-valley detection signal indicating detection of the peak or the valley of the tracking error signal by the predetermined number; and based on a comparison result between a phase of the tracking reference signal with a phase of the frequency-divided signal.

In the above arrangement, the wobble detecting signal concerning the track set is generated by integrating the tracking error signal to be obtained when the light beam is cyclically moved in the track set with the predetermined time constant. Then, the tracking reference signal having the frequency equal to the predetermined integral multiplication of the frequency of the wobble detecting signal is generated. Then, the frequency-divided signal is generated by frequency-dividing the peak-valley detection signal indicating detection of the peak or the valley of the tracking error signal by the predetermined number, and the phase control with respect to the movement of the light beam is performed based on the comparison result between the phase of the tracking reference signal with the phase of the frequency-divided signal.

Thus, a tracking reference signal equivalent to the tracking reference signal obtained by sampling the tracking error signal at the predetermined phase can be generated by integrating with the proper time constant, without sampling the tracking error signal at the predetermined phase. The phase of the movement of the light beam in the track set can be controlled, using the thus-generated tracking reference signal.

In the tracking control method, preferably, two outer reference phase pits, displaced from each other by an interval corresponding to (N+0.5) times as large as one-channel bit length of a recording code to be recorded in a tracking direction, are formed in advance in outermost tracks of the track set, respectively, and in the fourth step, a phase control with respect to the movement of the light beam is performed in such a manner that a peak of a reproduction signal to be generated when the light beam crosses the two outer reference phase pits is coincident with a timing corresponding to a maximal amplitude of the light beam.

In the above arrangement, the two outer reference phase pits, displaced from each other by the interval corresponding to (N+0.5) times as large as one-channel bit length of the recording code to be recorded in the tracking direction, are formed in advance in the outermost tracks of the track set, respectively. The phase control with respect to the movement of the light beam is performed in such a manner that the peak of the reproduction signal to be generated when the light beam crosses the two outer reference phase pits corresponds to the timing at the maximal amplitude of the light beam.

Thus, the phase of the movement of the light beam can be properly controlled by making the peak of the reproduction signal to be generated when the light beam crosses the two outer reference phase pits formed in the outermost tracks of the track set coincident with the timing corresponding to the maximal amplitude of the light beam.

In the tracking control method, preferably, a middle reference phase pit is formed in advance in the middle track of the track set, and in the fourth step, a phase control with respect to the movement of the light beam is performed in such a manner that a peak of a reproduction signal to be generated when the light beam crosses the middle reference phase pit corresponds to a timing at a 0-degree phase or a 180-degree phase of the cycle of the movement of the light beam.

In the above arrangement, the middle reference phase pit is formed in advance in the middle track of the track set. The phase control with respect to the movement of the light beam is performed in such a manner that the peak of the reproduction signal to be generated when the light beam crosses the middle reference phase pit is coincident with the timing corresponding to the 0-degree phase or the 180-degree phase of the cycle of the movement of the light beam.

Thus, the phase of the movement of the light beam can be properly controlled by matching the peak of the reproduction signal to be generated when the light beam crosses the middle reference phase pit with the timing at the 0-degree phase or the 180-degree phase of the cycle of the movement of the light beam.

In the tracking control method, preferably, in the first step, a wobbling frequency and a wobbling phase, or a frequency and a phase of a middle reference phase pit are detected in a state that a control error is converged in a predetermined range by performing a tracking control with respect to the middle track of the track set; and a tracking control signal to be used in an initial stage of the second step is generated based on the detected wobbling frequency and the detected wobbling phase, or the detected cycle and the detected phase of the middle reference phase pit.

In the above arrangement, the wobbling frequency and the wobbling phase, or the frequency and the phase of the middle reference phase pit are detected in the state that the control error is converged in the predetermined range by performing the tracking control with respect to the middle track of the track set. The tracking control signal to be used in the initial stage of the second step is generated based on the detected wobbling frequency and the detected wobbling phase, or the detected cycle and the detected phase of the middle reference phase pit.

Thus, in the case where the middle track is wobbled, or in the case where the middle reference phase pit is recorded in the middle track, the control time can be shortened by generating the tracking control signal for controlling the phase in the tracking cycle of the light beam, matching the frequency and the phase of the tracking control signal with those of the wobbling track or the middle reference phase pit, and using the tracking control signal as an initial signal to be used in the amplitude control of the second step.

An optical recording apparatus according to another aspect of the invention comprises: a laser; a laser power control circuit for controlling an optical power of laser light to be impulsively outputted from the laser in response to receiving recording data and a tracking middle signal; a collimator lens for collimating the laser light outputted from the laser into parallel light; an EO refractive device for refracting the parallel light collimated by the collimator lens in a radial direction of an optical recording medium, based on a refractive index control signal for cyclically moving the laser light with a predetermined pattern in adjacent tracks of a predetermined number; an objective lens for condensing the parallel light refracted by the EO refractive device to form a focus spot on the track in a recording layer of the optical recording medium; a tracking error detecting circuit for receiving reflected light from the focus spot to output a tracking error signal and the tracking middle signal indicating a middle of the track; a refraction control circuit for receiving the tracking error signal to output the refractive index control signal to the EO refractive device; an amplitude middle error detecting circuit for receiving the tracking error signal to output an amplitude middle error signal obtained by averaging the tracking error signal which has been detected in a predetermined period; and an actuator for driving the objective lens based on the amplitude middle error signal.

In the above arrangement, the laser power control circuit controls the optical power of the laser light to be impulsively outputted from the laser in response to receiving the recording data and the tracking middle signal. The collimator lens collimates the laser light outputted from the laser into the parallel light. The EO refractive device refracts the parallel light collimated by the collimator lens in the radial direction of the optical recording medium, based on the refractive index control signal for cyclically moving the laser light with the predetermined pattern in the adjacent tracks of the predetermined number. The objective lens condenses the parallel light refracted by the EO refractive device to form the focus spot on the track in the recording layer of the optical recording medium. The tracking error detecting circuit receives the reflected light from the focus spot to output the tracking error signal and the tracking middle signal indicating the middle of the track. The refraction control circuit receives the tracking error signal to output, to the EO refractive device, the refractive index control signal for cyclically moving the light beam with the predetermined pattern in the adjacent tracks of the predetermined number. The amplitude middle error detecting circuit receives the tracking error signal to output, to the actuator, the amplitude middle error signal obtained by averaging the tracking error signal which has been detected in the predetermined period. The actuator drives the objective lens based on the amplitude middle error signal.

Thus, the time required for data recording can be shortened by recording data while impulsively controlling the power of the laser light when the light beam crosses the middle of each of the adjacent tracks of the predetermined number, thereby enabling to increase the data transfer rate.

In the optical recording apparatus, preferably, the refraction control circuit includes: an amplitude detecting circuit for receiving the tracking error signal, and a tracking cycle signal indicating a tracking cycle of a light beam to output an amplitude control signal, a frequency-divided signal, and a pit phase detection/selection signal; a wobble detecting circuit for receiving the tracking error signal to output a tracking reference signal; a frequency comparing circuit for receiving the tracking reference signal and the frequency-divided signal to output a frequency control signal; a phase comparing circuit for receiving the tracking reference signal and the frequency-divided signal to output a phase comparing signal; a pit phase detecting circuit for receiving a reproduction signal to be generated by receiving reflected light from the focus spot, the pit phase detection/selection signal, and the frequency-divided signal to output a pit phase error signal; a selecting circuit for receiving the amplitude comparing signal, the frequency comparing signal, the phase comparing signal, the pit phase comparing signal, and a selection signal to output a VCO control signal; a VCO for receiving the VCO control signal and the amplitude control signal to output the refraction control signal and the tracking cycle signal; and a selection control circuit for receiving the amplitude control signal, the frequency comparing signal, the phase comparing signal, and the pit phase error signal to output the selection signal to the selecting circuit.

In the optical recording apparatus, preferably, the amplitude detecting circuit includes: a peak-valley detection counter for receiving the tracking error signal and the tracking cycle signal to repeatedly count up the number of peaks of the tracking error signal in a period indicated by the tracking cycle signal; a sequence control circuit for outputting a wave end level comparison enable signal indicating predetermined two counter values when the value of the peak-valley detection counter is counted up to a predetermined value in one cycle; and a wave end level comparing circuit for receiving the tracking error signal and the wave end level comparison enable signal to output an amplitude control signal indicating a difference between a maximal value of the tracking error signal in a first period when the wave end level comparison enable signal is asserted, and a minimal value of the tracking error signal in a second period different from the first period.

In the optical recording apparatus, preferably, the amplitude detecting circuit further includes: a peak-valley detection circuit for outputting a peak cycle signal indicating a cycle of a peak of the trajectory of the light beam to be moved in the track, and a valley cycle signal indicating a cycle of a valley of the trajectory of the light beam to be moved in the track, wherein the pit phase detecting circuit includes a peak detecting circuit for receiving the peak cycle signal, the valley cycle signal, the reproduction signal, and the pit phase detection/selection signal, and detecting a peak of the reproduction signal in a period when the pit phase detection/selection signal is asserted to output a peak detection signal, and a peak phase comparing circuit for comparing the phases of the peak detection signal, the peak cycle signal, and the valley cycle signal to output the pit phase error signal.

In the optical recording apparatus, preferably, the sequence control circuit outputs a recording enable signal indicating a period when the light beam is moved in a predetermined track; the laser power control circuit receives the recording enable signal, the recording data, and the tracking middle signal, controls the optical power of the laser light to a recording power in accordance with the recording data when both of the recording enable signal and the tracking middle signal are asserted, controls the optical power of the laser light to a reproduction power when the recording enable signal is negated; and the optical recording apparatus further comprises an analog-to-digital converter for receiving the tracking middle signal, the reproduction signal, and the recording enable signal, and sampling the reproduction signal when the recording enable signal is negated and the tracking middle signal is asserted.

An optical reproduction apparatus according to another aspect of the invention comprises: a laser; a laser power control circuit for controlling an optical power of laser light to be outputted from the laser to a predetermined value; a collimator lens for collimating the laser light outputted from the laser into parallel light; an EO refractive device for cyclically moving the laser light with a predetermined pattern in adjacent tracks of a predetermined number, and for refracting the parallel light collimated by the collimator lens in a radial direction of an optical recording medium, based on a refractive index control signal to be used in matching a tracking cycle of the laser light with a cycle of one-channel bit length of a recording code to be recorded in a tracking direction; an objective lens for condensing the parallel light refracted by the EO refractive device to form a focus spot on the track in a recording layer of the optical recording medium; an actuator for driving the objective lens; a tracking error detecting circuit for receiving reflected light from the focus spot to output a tracking error signal, a tracking middle signal indicating a middle of each of the tracks, and a reproduction signal; a refraction control circuit for receiving the tracking error signal to output the refractive index control signal to the EO refractive device; an amplitude middle error detecting circuit for receiving the tracking error signal to output an amplitude middle error signal obtained by averaging the tracking error signal which has been detected in a predetermined period; an actuator for driving the objective lens based on the amplitude middle error signal; and an analog-to-digital converter for receiving the tracking middle signal and the reproduction signal, and sampling the reproduction signal when the tracking middle signal is asserted to output reproduction data.

In the above arrangement, the laser power control circuit controls the optical power of the laser light to be outputted from the laser to the predetermined value. The collimator lens collimates the laser light outputted from the laser into the parallel light. The EO refractive device cyclically moves the laser light with the predetermined pattern in the adjacent tracks of the predetermined number, and refracts the parallel light collimated by the collimator lens in the radial direction of the optical recording medium, based on the refractive index control signal to be used in matching the tracking cycle of the laser light with the cycle of one-channel bit length of the recording code to be recorded in the tracking direction. The objective lens condenses the parallel light refracted by the EO refractive device to form the focus spot on the track in the recording layer of the optical recording medium. The tracking error detecting circuit receives the reflected light from the focus spot to output the tracking error signal, the tracking middle signal indicating the middle of the track, and the reproduction signal. The refraction control circuit receives the tracking error signal to output the refractive index control signal to the EO refractive device. The amplitude middle error detecting circuit receives the tracking error signal to output, to the actuator, the amplitude middle error signal obtained by averaging the tracking error signal which has been detected in the predetermined period. The actuator drives the objective lens based on the amplitude middle error signal. The analog-to-digital converter receives the tracking middle signal and the reproduction signal, and samples the reproduction signal when the tracking middle signal is asserted to output the reproduction data.

Thus, the data recorded with a high density can be reproduced by reproducing the data while controlling the optical power of the laser light when the laser light is cyclically moved in one-channel bit, and the laser light crosses the middle of the track.

In the optical reproduction apparatus, preferably, the refraction control circuit includes: an amplitude detecting circuit for receiving the tracking error signal, and a tracking cycle signal to output an amplitude control signal, a frequency-divided signal, and a pit phase detection/selection signal; a wobble detecting circuit for receiving the tracking error signal to output a tracking reference signal; a frequency comparing circuit for receiving the tracking reference signal and the frequency-divided signal to output a frequency control signal; a phase comparing circuit for receiving the tracking reference signal and the frequency-divided signal to output a phase comparing signal; a pit phase detecting circuit for receiving the reproduction signal, the pit phase detection/selection signal, and the frequency-divided signal to output a pit phase error signal; a selecting circuit for receiving the amplitude comparing signal, the frequency comparing signal, the phase comparing signal, the pit phase comparing signal, and a selection signal to output a VCO control signal; a VCO for receiving the VCO control signal and the amplitude control signal to output the refraction control signal and the tracking cycle signal; and a selection control circuit for receiving the amplitude control signal, the frequency comparing signal, the phase comparing signal, and the pit phase error signal to output the selection signal to the selecting circuit.

In the optical reproduction apparatus, preferably, the amplitude detecting circuit includes: a peak-valley detection counter for receiving the tracking error signal and the tracking cycle signal to repeatedly count up the number of peaks of the tracking error signal in a period indicated by the tracking cycle signal; a sequence control circuit for outputting a wave end level comparison enable signal indicating predetermined two counter values when the value of the peak-valley detection counter is counted up to a predetermined value in one cycle; and a wave end level comparing circuit for receiving the tracking error signal and the wave end level comparison enable signal to output an amplitude control signal indicating a difference between a maximal value of the tracking error signal in a first period when the wave end level comparison enable signal is asserted, and a minimal value of the tracking error signal in a second period different from the first period.

In the optical reproduction apparatus, preferably, the amplitude detecting circuit further includes: a peak-valley detection circuit for outputting a peak cycle signal indicating a cycle of a peak of the trajectory of the light beam to be moved in the track, and a valley cycle signal indicating a cycle of a valley of the trajectory of the light beam to be moved in the track, wherein the pit phase detecting circuit includes a peak detecting circuit for receiving the peak cycle signal, the valley cycle signal, the reproduction signal, and the pit phase detection/selection signal, and detecting a peak of the reproduction signal in a period when the pit phase detection/selection signal is asserted to output a peak detection signal, and a peak phase comparing circuit for comparing the phases of the peak detection signal, the peak cycle signal, and the valley cycle signal to output the pit phase error signal.

An optical recording control circuit according to another aspect of the invention comprises: a laser power control circuit for controlling an optical power of laser light to be impulsively outputted from a laser in response to receiving recording data and a tracking middle signal; a tracking error detecting circuit for receiving reflected light from a focus spot formed by condensing laser light refracted by an EO refractive device on a track in a recording layer of an optical recording medium through an objective lens to output a tracking error signal and a tracking middle signal indicating a middle of the track; a refraction control circuit for receiving the tracking error signal to output, to the EO refractive device, a refractive index control signal to be used in cyclically moving the laser light with a predetermined pattern in adjacent tracks of a predetermined number; and an amplitude middle error detecting circuit for receiving the tracking error signal to output an amplitude middle error signal obtained by averaging the tracking error signal which has been detected in a predetermined period to an actuator for driving the objective lens.

In the above arrangement, the laser power control circuit controls the optical power of the laser light to be impulsively outputted from the laser in response to receiving the recording data and the tracking middle signal. The tracking error detecting circuit receives the reflected light from the focus spot formed by condensing the laser light refracted by the EO refractive device on the track in the recording layer of the optical recording medium through the objective lens to output the tracking error signal and the tracking middle signal indicating the middle of the track. The refraction control circuit receives the tracking error signal to output, to the EO refractive device, the refractive index control signal to be used in cyclically moving the laser light with the predetermined pattern in the adjacent tracks of the predetermined number. The amplitude middle error detecting circuit receives the tracking error signal to output the amplitude middle error signal obtained by averaging the tracking error signal which has been detected in the predetermined period to the actuator for driving the objective lens.

Thus, the time required for data recording can be shortened by recording the data while impulsively controlling the power of the laser light when the light beam crosses the middle of each of the adjacent tracks of the predetermined number for data recording, thereby enabling to increase the data transfer rate.

In the optical recording control circuit, preferably, the refraction control circuit includes: an amplitude detecting circuit for receiving the tracking error signal, and a tracking cycle signal to output an amplitude control signal, a frequency-divided signal, and a pit phase detection/selection signal; a wobble detecting circuit for receiving the tracking error signal to output a tracking reference signal; a frequency comparing circuit for receiving the tracking reference signal and the frequency-divided signal to output a frequency control signal; a phase comparing circuit for receiving the tracking reference signal and the frequency-divided signal to output a phase comparing signal; a pit phase detecting circuit for receiving a reproduction signal to be generated by receiving reflected light from the focus spot, the pit phase detection/selection signal, and the frequency-divided signal to output a pit phase error signal; a selecting circuit for receiving the amplitude comparing signal, the frequency comparing signal, the phase comparing signal, the pit phase comparing signal, and a selection signal to output a VCO control signal; a VCO for receiving the VCO control signal and the amplitude control signal to output the refraction control signal and the tracking cycle signal; and a selection control circuit for receiving the amplitude control signal, the frequency comparing signal, the phase comparing signal, and the pit phase error signal to output the selection signal to the selecting circuit.

In the optical recording control circuit, preferably, the amplitude detecting circuit includes: a peak-valley detection counter for receiving the tracking error signal and the tracking cycle signal to repeatedly count up the number of peaks of the tracking error signal in a period indicated by the tracking cycle signal; a sequence control circuit for outputting a wave end level comparison enable signal indicating predetermined two counter values when the value of the peak-valley detection counter is counted up to a predetermined value in one cycle; and a wave end level comparing circuit for receiving the tracking error signal and the wave end level comparison enable signal to output an amplitude control signal indicating a difference between a maximal value of the tracking error signal in a first period when the wave end level comparison enable signal is asserted, and a minimal value of the tracking error signal in a second period different from the first period.

In the optical recording control circuit, preferably, the amplitude detecting circuit further includes: a peak-valley detection circuit for outputting a peak cycle signal indicating a cycle of a peak of the trajectory of the light beam to be moved in the track, and a valley cycle signal indicating a cycle of a valley of the trajectory of the light beam to be moved in the track, wherein the pit phase detecting circuit includes a peak detecting circuit for receiving the peak cycle signal, the valley cycle signal, the reproduction signal, and the pit phase detection/selection signal, and detecting a peak of the reproduction signal in a period when the pit phase detection/selection signal is asserted to output a peak detection signal, and a peak phase comparing circuit for comparing the phases of the peak detection signal, the peak cycle signal, and the valley cycle signal to output the pit phase error signal.

In the optical recording control circuit, preferably, the sequence control circuit outputs a recording enable signal indicating a period when the light beam is moved in a predetermined track; the laser power control circuit receives the recording enable signal, the recording data, and the tracking middle signal, controls the optical power of the laser light to a recording power in accordance with the recording data when both of the recording enable signal and the tracking middle signal are asserted, controls the optical power of the laser light to a reproduction power when the recording enable signal is negated; and the optical recording control circuit further comprises an analog-to-digital converter for receiving the tracking middle signal, the reproduction signal, and the recording enable signal, and sampling the reproduction signal when the recording enable signal is negated and the tracking middle signal is asserted.

An optical reproduction control circuit according to yet another aspect of the invention comprises: a laser power control circuit for controlling an optical power of laser light to be outputted from a laser to a predetermined value; a tracking error detecting circuit for receiving reflected light from a focus spot formed by condensing the laser light refracted by an EO refractive device on a track in a recording layer of an optical recording medium through an objective lens to output a tracking error signal, a tracking middle signal indicating a middle of the track, and a reproduction signal; a refraction control circuit for receiving the tracking error signal to cyclically move the laser light with a predetermined pattern in adjacent tracks of a predetermined number, and for outputting, to the EO refractive device, a refractive index control signal to be used in matching a tracking cycle of the laser light with a cycle of one-channel bit length of a recording code to be recorded in a tracking direction; an amplitude middle error detecting circuit for receiving the tracking error signal to output an amplitude middle error signal obtained by averaging the tracking error signal which has been detected in a predetermined period to an actuator for driving the objective lens; and an analog-to-digital converter for receiving the tracking middle signal and the reproduction signal, and sampling the reproduction signal when the tracking middle signal is asserted to output reproduction data.

In the above arrangement, the laser power control circuit controls the optical power of the laser light to be outputted from the laser to the predetermined value. The tracking error detecting circuit receives the reflected light from the focus spot formed by condensing the laser light refracted by the EO refractive device on the track in the recording layer of the optical recording medium through the objective lens to output the tracking error signal, the tracking middle signal indicating the middle of the track, and the reproduction signal. The refraction control circuit receives the tracking error signal to cyclically move the laser light with the predetermined pattern in the adjacent tracks of the predetermined number, and outputs, to the EO refractive device, the refractive index control signal to be used in matching the tracking cycle of the laser light with the cycle of one-channel bit length of the recording code to be recorded in the tracking direction. The amplitude middle error detecting circuit receives the tracking error signal to output the amplitude middle error signal obtained by averaging the tracking error signal which has been detected in the predetermined period to the actuator for driving the objective lens. The analog-to-digital converter receives the tracking middle signal and the reproduction signal, and samples the reproduction signal when the tracking middle signal is asserted to output the reproduction data.

Thus, the data recorded with a high density can be reproduced by reproducing the data while controlling the optical power of the laser light when the laser light is cyclically moved in one-channel bit, and the laser light crosses the middle of the track.

In the optical reproduction control circuit, preferably, the refraction control circuit includes: an amplitude detecting circuit for receiving the tracking error signal, and a tracking cycle signal to output an amplitude control signal, a frequency-divided signal, and a pit phase detection/selection signal; a wobble detecting circuit for receiving the tracking error signal to output a tracking reference signal; a frequency comparing circuit for receiving the tracking reference signal and the frequency-divided signal to output a frequency control signal; a phase comparing circuit for receiving the tracking reference signal and the frequency-divided signal to output a phase comparing signal; a pit phase detecting circuit for receiving a reproduction signal, the pit phase detection/selection signal, and the frequency-divided signal to output a pit phase error signal; a selecting circuit for receiving the amplitude comparing signal, the frequency comparing signal, the phase comparing signal, the pit phase comparing signal, and a selection signal to output a VCO control signal; a VCO for receiving the VCO control signal and the amplitude control signal to output the refraction control signal and the tracking cycle signal; and a selection control circuit for receiving the amplitude control signal, the frequency comparing signal, the phase comparing signal, and the pit phase error signal to output the selection signal to the selecting circuit.

In the optical reproduction control circuit, preferably, the amplitude detecting circuit includes: a peak-valley detection counter for receiving the tracking error signal and the tracking cycle signal to repeatedly count up the number of peaks of the tracking error signal in a period indicated by the tracking cycle signal; a sequence control circuit for outputting a wave end level comparison enable signal indicating predetermined two counter values when the value of the peak-valley detection counter is counted up to a predetermined value in one cycle; and a wave end level comparing circuit for receiving the tracking error signal and the wave end level comparison enable signal to output an amplitude control signal indicating a difference between a maximal value of the tracking error signal in a first period when the wave end level comparison enable signal is asserted, and a minimal value of the tracking error signal in a second period different from the first period.

In the optical reproduction control circuit, preferably, the amplitude detecting circuit further includes: a peak-valley detection circuit for outputting a peak cycle signal indicating a cycle of a peak of the trajectory of the light beam to be moved in the track, and a valley cycle signal indicating a cycle of a valley of the trajectory of the light beam to be moved in the track, wherein the pit phase detecting circuit includes a peak detecting circuit for receiving the peak cycle signal, the valley cycle signal, the reproduction signal, and the pit phase detection/selection signal, and detecting a peak of the reproduction signal in a period when the pit phase detection/selection signal is asserted to output a peak detection signal, and a peak phase comparing circuit for comparing the phases of the peak detection signal, the peak cycle signal, and the valley cycle signal to output the pit phase error signal.

### Exploitation in Industry

The optical recording control method, the optical recording control circuit, the optical reproduction control method, the optical reproduction control circuit, the optical recording medium, the tracking control method, the tracking control circuit, the optical recording method, the optical recording apparatus, the optical reproduction method, and the optical reproduction apparatus are useful in recording and reproducing digital data, and the like.

1-44. (canceled)

45. An optical recording control method, comprising:
a movement designation step of designating a light beam to cyclically move in a track set with a predetermined pattern, the track set being constituted of adjacent tracks of a predetermined number; and
a recording designation step of designating recording of data in the track set by controlling a power of the light beam so that the light beam is impulsively irradiated with a predetermined intensity when the light beam crosses a middle of each of the tracks, wherein
the cycle of the movement of the light beam in the track set is coincident with a cycle of one-channel bit length of a recording code to be recorded in a tracking direction.

46. The optical recording control method according to claim 45, wherein
the track set is constituted of the tracks of an odd number.

47. The optical recording control method according to claim 45, wherein
a trajectory of the light beam to be moved in the track set has a triangular waveform.

48. The optical recording control method according to claim 45, wherein
a trajectory of the light beam to be moved in the track set has a sinusoidal waveform.

49. The optical recording control method according to claim 46, wherein
the recording designation step includes:
designating recording of the data in the track other than outermost tracks of the track set by controlling the power of the light beam so that the light beam is impulsively irradiated with the predetermined intensity when the light beam crosses the middle of the track other than the outermost tracks of the track set.

50. The optical recording control method according to claim 45, wherein
the recording designation step includes designating recording of the data in the track set or in the track other than outermost tracks of the track set by controlling the power of the light beam so that the light beam is impulsively irradiated with the predetermined intensity when the cycle of the movement of the light beam in the track set is in a range from a 90-degree phase to a 270-degree phase,
the optical recording control method further comprising:
a reproduction designation step of:
designating reproduction of data recorded in the track set or in the track other than outermost tracks of the track set by controlling the power of the light beam to a reproduction power when the cycle of the movement of the light beam in the track set is in a range from the 270-degree phase to the 90-degree phase, and by sampling a reproduction signal to be generated in receiving reflected light of the light beam when the light beam crosses the track set or the middle of the track other than the outermost tracks of the track set.

51. An optical reproduction control method, comprising:
a movement designation step of designating a light beam to cyclically move in a track set with a predetermined pattern, the track set being constituted of adjacent tracks of a predetermined number; and
a reproduction designation step of designating reproduction of data recorded in the track set by sampling a reproduction signal to be generated in receiving reflected light of the light beam when the light beam crosses a middle of the track, wherein
the cycle of the movement of the light beam in the track set is coincident with a cycle of one-channel bit length of a recording code to be recorded in a tracking direction.

52. The optical reproduction control method according to claim 51, wherein
the track set is constituted of the tracks of an odd number.

53. The optical reproduction control method according to claim 51, wherein
a trajectory of the light beam to be moved in the track set has a triangular waveform.

54. The optical reproduction control method according to claim 51, wherein
a trajectory of the light beam to be moved in the track set has a sinusoidal waveform.

55. The optical reproduction control method according to claim 51, wherein
the reproduction designation step includes:
designating reproduction of the data recorded in the track other than outermost tracks of the track set by sampling a reproduction signal to be generated in receiving reflected light of the light beam when the light beam crosses the middle of the track other than the outermost tracks of the track set.

56. The optical reproduction control method according to claim 51, wherein
the reproduction designation step includes:
designating reproduction of the data recorded in the track set or in the track other than outermost tracks of the track set by controlling a power of the light beam to a reproduction power when the cycle of the movement of the light beam in the track set is in a range from a 90-degree phase to a 270-degree phase, and by sampling a reproduction signal to be generated in receiving reflected light of the light beam when the light beam crosses the track set or the middle of the track other than the outermost tracks of the track set; and
designating reproduction of the data recorded in the track set or in the track other than the outermost tracks of the track set by controlling the power of the light beam to the reproduction power when the cycle of the movement of the light beam in the track set is in a range from the 270-degree phase to the 90-degree phase, and by sampling the reproduction signal when the light beam crosses the track set or the middle of the track other than the outermost tracks of the track set.

57. An optical recording medium, comprising:
a plurality of tracks; and
a recording layer, wherein
the adjacent tracks of a predetermined number constitute a track set,
an interval between the track sets adjacent to each other is set wider than an interval between the tracks of each of the track sets, and
the middle track or the two middle tracks of the track set is or are wobbled at a predetermined amplitude and at a predetermined cycle.

58. The optical recording medium according to claim 57, wherein
each of outermost tracks of the track set has a straight-line shape, and
the track other than the outermost tracks of the track set is wobbled.

59. The optical recording medium according to claim 57, wherein
the track has a wobbling cycle equal to an integral multiplication of a cycle of a movement of a light beam in the track set.

60. The optical recording medium according to claim 59, wherein
the wobbling cycle of the track is set to an integral multiplication of one-channel bit length of a recording code to be recorded in the track.

61. The optical recording medium according to claim 60, wherein
reference phase pits are formed in outermost tracks of the track set, displaced from each other by (N+0.5) cycle with respect to a cycle of the one-channel bit length, where N is an integer.

62. An optical recording medium, comprising:
a track; and
a plurality of recording layers, wherein
the track is formed in a farthest layer, of the recording layers, from an incident surface of a light beam, the farthest layer having a structure identical to a structure of the optical recording medium of claim 57.

63. A tracking control method, comprising:
a first step of performing a tracking control with respect to a middle track of a track set, the track set being constituted of adjacent tracks of a predetermined number;
a second step of controlling a light beam to be cyclically moved with a predetermined magnitude of amplitude, with a middle of the middle track of the track set being defined as a center of a trajectory of the light beam;
a third step of controlling the light beam to be cyclically moved in the track set with a predetermined cycle; and
a fourth step of controlling the light beam to be cyclically moved in the track set with a predetermined phase corresponding to a predetermined position of the track set.

64. The tracking control method according to claim 63, wherein
in the second step, a center position control with respect to the movement of the light beam is performed by detecting a tracking error signal at a 0-degree phase and a 180-degree phase of the cycle of the movement of the light beam in the track set, as a displacement between the middle of the middle track of the track set, and a center of the cyclic movement of the light beam.

65. The tracking control method according to claim 63, wherein
in the second step, a center position control with respect to the movement of the light beam is performed by detecting a tracking error signal integrated with a predetermined time constant, as a displacement between the middle of the middle track of the track set, and a center of the cyclic movement of the light beam.

66. The tracking control method according to claim 63, wherein
in the second step, the amplitude of the movement of the light beam is controlled by setting the number of peaks of a tracking error signal in one cycle of the movement of the light beam to a predetermined value.

67. The tracking control method according to claim 63, wherein
in the second step, the amplitude of the movement of the light beam is controlled with a difference signal of a tracking error signal at two maximal amplitudes of the movement of the light beam, the tracking error signal being detected in one cycle of the movement of the light beam.

68. The tracking control method according to claim 64, wherein
in the third step, a cycle control with respect to the movement of the light beam is performed:
by generating a wobble detecting signal concerning the track set by detecting the tracking error signal at a predetermined phase in the cyclic movement of the light beam in the track set;
by generating a tracking reference signal having a frequency equal to a predetermined integral multiplication of a frequency of the wobble detecting signal;
by generating a frequency-divided signal by frequency-dividing a peak-valley detection signal indicating detection of a peak or a valley of the tracking error signal by a predetermined number; and
based on a comparison result between the frequency of the tracking reference signal with a frequency of the frequency-divided signal.

69. The tracking control method according to claim 64, wherein
in the third step, a cycle control with respect to the movement of the light beam is performed:
by generating a wobble detecting signal concerning the track set by integrating the tracking error signal to be obtained when the light beam is cyclically moved in the track set with a predetermined time constant;
by generating a tracking reference signal having a frequency equal to a predetermined integral multiplication of a frequency of the wobble detecting signal;
by generating a frequency-divided signal by frequency-dividing a peak-valley detection signal indicating detection of a peak or a valley of the tracking error signal by a predetermined number; and
based on a comparison result between the frequency of the tracking reference signal with a frequency of the frequency-divided signal.

70. The tracking control method according to claim 68, wherein
the tracking reference signal has a cycle coincident with an integral multiplication of a cycle of one-channel bit length of a recording code to be recorded in a tracking direction.

71. The tracking control method according to claim 68, wherein
in the fourth step, a phase control with respect to the movement of the light beam is performed:
by generating the wobble detecting signal concerning the track set by detecting the tracking error signal at the predetermined phase in the cycle of the movement of the light beam in the track set;
by generating the tracking reference signal having the frequency equal to the predetermined integral multiplication of the frequency of the wobble detecting signal;
by generating the frequency-divided signal by frequency-dividing the peak-valley detection signal indicating detection of the peak or the valley of the tracking error signal by the predetermined number; and
based on a comparison result between a phase of the tracking reference signal with a phase of the frequency-divided signal.

72. The tracking control method according to claim 68, wherein
in the fourth step, a phase control concerning the movement of the light beam is performed:
by generating the wobble detecting signal concerning the track set by integrating the tracking error signal to be obtained when the light beam is cyclically moved in the track set with the predetermined time constant;
by generating the tracking reference signal having the frequency equal to the predetermined integral multiplication of the frequency of the wobble detecting signal;
by generating the frequency-divided signal by frequency-dividing the peak-valley detection signal indicating detection of the peak or the valley of the tracking error signal by the predetermined number; and
based on a comparison result between a phase of the tracking reference signal with a phase of the frequency-divided signal.

73. The tracking control method according to claim 68, wherein
two outer reference phase pits, displaced from each other by an interval corresponding to (N+0.5) times as large as one-channel bit length of a recording code to be recorded in a tracking direction, are formed in advance in outermost tracks of the track set, respectively, and
in the fourth step, a phase control with respect to the movement of the light beam is performed in such a manner that a peak of a reproduction signal to be generated when the light beam crosses the two outer reference phase pits corresponds to a timing at a maximal amplitude of the light beam.

74. The tracking control method according to claim 68, wherein
a middle reference phase pit is formed in advance in the middle track of the track set, and
in the fourth step, a phase control with respect to the movement of the light beam is performed in such a manner that a peak of a reproduction signal to be generated when the light beam crosses the middle reference phase pit corresponds to a timing at a 0-degree phase or a 180-degree phase of the cycle of the movement of the light beam.

75. The tracking control method according to claim 71, wherein
in the first step,
a wobbling frequency and a wobbling phase, or a frequency and a phase of a middle reference phase pit are detected in a state that a control error is converged in a predetermined range by performing a tracking control with respect to the middle track of the track set; and
a tracking control signal to be used in an initial stage of the second step is generated based on the detected wobbling frequency and the detected wobbling phase, or the detected cycle and the detected phase of the middle reference phase pit.

76. An optical recording control circuit, comprising:
a movement designator for designating a light beam to cyclically move in a track set with a predetermined pattern, the track set being constituted of adjacent tracks of a predetermined number; and
a recording designator for designating recording of data in the track set by controlling a power of the light beam so that the light beam is impulsively irradiated with a predetermined intensity when the light beam crosses a middle of each of the tracks, wherein
the cycle of the movement of the light beam in the track set is coincident with a cycle of one-channel bit length of a recording code to be recorded in a tracking direction.

77. An optical recording method, comprising:
a moving step of cyclically moving a light beam in a track set with a predetermined pattern, the track set being constituted of adjacent tracks of a predetermined number; and
a recording step of recording data in the track set by controlling a power of the light beam so that the light beam is impulsively irradiated with a predetermined intensity when the light beam crosses a middle of each of the tracks, wherein
the cycle of the movement of the light beam in the track set is coincident with a cycle of one-channel bit length of a recording code to be recorded in a tracking direction.

78. An optical recording apparatus, comprising:
a mover for cyclically moving a light beam in a track set with a predetermined pattern, the track set being constituted of adjacent tracks of a predetermined number; and
a recorder for recording data in the track set by controlling a power of the light beam so that the light beam is impulsively irradiated with a predetermined intensity when the light beam crosses a middle of each of the tracks, wherein
the cycle of the movement of the light beam in the track set is coincident with a cycle of one-channel bit length of a recording code to be recorded in a tracking direction.

79. An optical reproduction control circuit, comprising:
a movement designator for designating a light beam to cyclically move in a track set with a predetermined pattern, the track set being constituted of adjacent tracks of a predetermined number; and
a reproduction designator for designating reproduction of data recorded in the track set by sampling a reproduction signal to be generated in receiving reflected light of the light beam when the light beam crosses a middle of the track, wherein
the cycle of the movement of the light beam in the track set is coincident with a cycle of one-channel bit length of a recording code to be recorded in a tracking direction.

80. An optical reproduction method, comprising:
a moving step of cyclically moving a light beam in a track set with a predetermined pattern, the track set being constituted of adjacent tracks of a predetermined number; and
a reproduction step of reproducing data recorded in the track set by sampling a reproduction signal to be generated in receiving reflected light of the light beam when the light beam crosses a middle of the track, wherein
the cycle of the movement of the light beam in the track set is coincident with a cycle of one-channel bit length of a recording code to be recorded in a tracking direction.

81. An optical reproduction apparatus, comprising:
a mover for cyclically moving a light beam in a track set with a predetermined pattern, the track set being constituted of adjacent tracks of a predetermined number; and
a reproducer for reproducing data recorded in the track set by sampling a reproduction signal to be generated in receiving reflected light of the light beam when the light beam crosses a middle of the track, wherein
the cycle of the movement of the light beam in the track set is coincident with a cycle of one-channel bit length of a recording code to be recorded in a tracking direction.

82. A tracking control circuit, comprising:
a tracking controller for performing a tracking control with respect to a middle track of a track set, the track set being constituted of adjacent tracks of a predetermined number;
an amplitude controller for controlling a light beam to be cyclically moved with a predetermined magnitude of amplitude, with a middle of the middle track of the track set being defined as a center of a trajectory of the light beam;
a cycle controller for controlling the light beam to be cyclically moved in the track set with a predetermined cycle; and
a phase controller for controlling the light beam to be cyclically moved in the track set with a predetermined phase corresponding to a predetermined position of the track set.

83. An optical recording apparatus, comprising:
a laser;
a laser power control circuit for controlling an optical power of laser light to be impulsively outputted from the laser in response to receiving recording data and a tracking middle signal;
a collimator lens for collimating the laser light outputted from the laser into parallel light;
an EO refractive device for refracting the parallel light collimated by the collimator lens in a radial direction of an optical recording medium, based on a refractive index control signal for cyclically moving the laser light with a predetermined pattern in adjacent tracks of a predetermined number;
an objective lens for condensing the parallel light refracted by the EO refractive device to form a focus spot on the track in a recording layer of the optical recording medium;
a tracking error detecting circuit for receiving reflected light from the focus spot to output a tracking error signal and the tracking middle signal indicating a middle of the track;
a refraction control circuit for receiving the tracking error signal to output the refractive index control signal to the EO refractive device;
an amplitude middle error detecting circuit for receiving the tracking error signal to output an amplitude middle error signal obtained by averaging the tracking error signal which has been detected in a predetermined period; and
an actuator for driving the objective lens based on the amplitude middle error signal.

84. An optical reproduction apparatus, comprising:
a laser;
a laser power control circuit for controlling an optical power of laser light to be outputted from the laser to a predetermined value;
a collimator lens for collimating the laser light outputted from the laser into parallel light;
an EO refractive device for cyclically moving the laser light with a predetermined pattern in adjacent tracks of a predetermined number, and for refracting the parallel light collimated by the collimator lens in a radial direction of an optical recording medium, based on a refractive index control signal to be used in matching a tracking cycle of the laser light with a cycle of one-channel bit length of a recording code to be recorded in a tracking direction;
an objective lens for condensing the parallel light refracted by the EO refractive device to form a focus spot on the track in a recording layer of the optical recording medium;
a tracking error detecting circuit for receiving reflected light from the focus spot to output a tracking error signal, a tracking middle signal indicating a middle of the track, and a reproduction signal;
a refraction control circuit for receiving the tracking error signal to output the refractive index control signal to the EO refractive device;
an amplitude middle error detecting circuit for receiving the tracking error signal to output an amplitude middle error signal obtained by averaging the tracking error signal which has been detected in a predetermined period;
an actuator for driving the objective lens based on the amplitude middle error signal; and
an analog-to-digital converter for receiving the tracking middle signal and the reproduction signal, and sampling the reproduction signal when the tracking middle signal is asserted to output reproduction data.

85. An optical recording control circuit, comprising:
a laser power control circuit for controlling an optical power of laser light to be impulsively outputted from a laser in response to receiving recording data and a tracking middle signal;
a tracking error detecting circuit for receiving reflected light from a focus spot formed by condensing laser light refracted by an EO refractive device on a track in a recording layer of an optical recording medium through an objective lens to output a tracking error signal and a tracking middle signal indicating a middle of the track;
a refraction control circuit for receiving the tracking error signal to output, to the EO refractive device, a refractive index control signal to be used in cyclically moving the laser light with a predetermined pattern in adjacent tracks of a predetermined number; and
an amplitude middle error detecting circuit for receiving the tracking error signal to output an amplitude middle error signal obtained by averaging the tracking error signal which has been detected in a predetermined period to an actuator for driving the objective lens.

86. An optical reproduction control circuit, comprising:
a laser power control circuit for controlling an optical power of laser light to be outputted from a laser to a predetermined value;
a tracking error detecting circuit for receiving reflected light from a focus spot formed by condensing the laser light refracted by an EO refractive device on a track in a recording layer of an optical recording medium through an objective lens to output a tracking error signal, a tracking middle signal indicating a middle of the track, and a reproduction signal;
a refraction control circuit for receiving the tracking error signal to cyclically move the laser light with a predetermined pattern in adjacent tracks of a predetermined number, and for outputting, to the EO refractive device, a refractive index control signal to be used in matching a tracking cycle of the laser light with a cycle of one-channel bit length of a recording code to be recorded in a tracking direction;
an amplitude middle error detecting circuit for receiving the tracking error signal to output an amplitude middle error signal obtained by averaging the tracking error signal which has been detected in a predetermined period to an actuator for driving the objective lens; and
an analog-to-digital converter for receiving the tracking middle signal and the reproduction signal, and sampling the reproduction signal when the tracking middle signal is asserted to output reproduction data.
